(19) United States
(12) Patent Application Publication
(10) Pub. No.: US 2017/0310746 A1
(43) Pub. Date: Oct. 26, 2017

(54) SYSTEM FOR COMMUNICATING WITH SELECT GROUP(S) OF USERS AND METHODS OF USE

(71) Applicant: Sony J. ROUNDHILL, Marietta, GA (US)

(72) Inventor: Sony J. ROUNDHILL, Marietta, GA (US)

(21) Appl. No.: 15/494,258

(22) Filed: Apr. 21, 2017

Related U.S. Application Data
(60) Provisional application No. 62/325,666, filed on Apr. 21, 2016.

(51) Int. Cl. H04L 29/08; G06Q 10/10

(52) U.S. Cl. CPC H04L 67/1044; H04L 67/306; G06Q 10/1097; H04L 67/20

(57) ABSTRACT

A computer-implemented method for communicating with select group(s) of users comprising executing the steps of providing a network, a database, an server running a business rules engine and communicating with said database, at least one first computer apparatus having a display and a network connection to communicate with said server, at least one second computer apparatus having a display and a network connection to communicate with said server, and a notification server configured to enable communication between a service provider via said at least one first computer apparatus and a service requestor via said at least one second computer apparatus and storage of said communication in said database; wherein said business rules engine is configured to enable searching of service providers by said service requestor, communicating between said service provider and said service requestor, selecting of said service provider, and scheduling of service to be performed by said service provider.

### CROSS-REFERENCE TO RELATED APPLICATIONS

To the full extent permitted by law, the present United States Non-provisional Patent Application hereby claims priority to and the full benefit of, U.S. Provisional Application No. 62/325,666, filed on Apr. 21, 2016, entitled “System for communicating with select group(s) of users,” which is incorporated herein by reference in its entirety.

### TECHNICAL FIELD

The disclosure relates generally to a system/platform for registered users to request services and, more specifically, how service requests are originated and fulfilled.

### BACKGROUND

Traditionally a business entity or service provider wanting to perform a service for a client generates leads to potential prospects through advertisements in local print distributions and the yellow pages phone book and a service requestor who is looking for a service provider would scan such print distributions and the yellow pages or rely on word-of-mouth leads to find a service provider. However, with the advent of the Internet, a variety of online means have dominated the old print models, such as Google, Angie's List, Craig's List, Yelp, CareerBuilder, LinkedIn, service provider websites, social media websites and Apps, and the like Internet marketing tools. Such Internet tools enable service providers to display descriptive text, picture, and video content, contact information, hours of operation, and other service provider content accessible via Internet. Moreover, Internet tools enable a service requestor to search and review list of service providers and their service provider content, and compare between service providers. Service provider searches are enabled for a variety of local and distant service providers whether for physical services, such as like plumbing, electrical, lawn services, and the like or for soft skills, such as software development, sales and marketing, management, and the like, and more specifically service provider lists may be generated based on service requestor's keywords, reviews, and proximity to service requestor.

One disadvantage of this approach is that the service requestor is limited to a list of expensive service providers that have spent considerable money to actively market their services and rank within these Internet marketing tools, thus excluding a large pool of service providers who do not rank on page one or who do not actively market their services via costly Internet marketing tools.

Another disadvantage of this approach is that hobbyists who could help with a service request in their spare time are very difficult to locate. The current Internet marketing tools leave service requestors with i) having to spend considerable time and effort searching to locate poorly ranked nonpaying service providers or hobbyist service providers or ii) alternatively paying a higher premium for ranked paid marketing service providers found on page one.

Another disadvantage is time spent reviewing and trying to contact ranked service providers. For example, a home owner (service requestor) looking for a plumber (service provider) will have to spend considerable time and effort to search and review and reach out via phone or e-mail to at least half a dozen ranked service providers before finding a service provider that meets the home owner's needs and is readily available.

Therefore, it is readily apparent that there is a recognizable unmet need for system for communicating with select group(s) of users and methods of use that functions to overcome the inefficient market place that currently exists for services all around the world where service providers have to constantly mass market their services at considerable expenses, thereby increasing the cost of their services, and where service requestors have to spend considerable time and effort to find expensive service providers. Moreover, to alleviate the market inefficiency where a service provider does not know exactly when a service requestor needs a service, and where a service requestor does not have access to the list of all possible service providers that can fulfil their needs.

### BRIEF SUMMARY

Briefly described, in an example embodiment, the present system and method overcomes the above-mentioned disadvantages, and meets the recognized need for a system for communicating with select group(s) of users and methods of use, including, in general, a computer-implemented method for communicating with select group(s) of users comprising executing the steps of providing a network, a database, an server running a business rules engine and communicating with said database, at least one first computer apparatus having a display and a network connection to communicate with said server, at least one second computer apparatus having a display and a network connection to communicate with said server, and a notification server configured to enable communication between a service provider via said at least one first computer apparatus and a service requestor via said at least one second computer apparatus and storage of said communication in said database; wherein said business rules engine is configured to enable searching of service providers by said service requestor, communicating between said service provider and said service requestor, selecting of said service provider, and scheduling of a service to be performed by said service provider and thus, alleviate the market inefficiency where a service provider now knows exactly when a service requestor needs a service, and a service requestor has access to the list of all possible service providers that can fulfil their needs.

Another modality of the system includes wherein said system enables communicating between said at least one first computer apparatus and said at least one second computer apparatus, terminating said communication, and deleting said communication from said at least one first computer apparatus and said at least one second computer apparatus.

Another modality of the system includes wherein said system enables adding a skill, communicating regarding said skill, deleting said skill, and deleting said communication regarding said skill from said at least one first computer apparatus and said at least one second computer apparatus.

Another modality of the system includes wherein said system enables adding a service request, communicating regarding said service request, closing said service request, and deleting said communication regarding said service request from said at least one first computer apparatus and said at least one second computer apparatus.

Another modality of the system includes wherein said system enables adding a service request, communicating regarding said service request, closing said service request, and deleting said communication regarding said service request from said at least one first computer apparatus and said at least one second computer apparatus.

Another modality of the system includes wherein said system enables community group posts, communicating within the community groups, deleting communications in the community groups.

In an exemplary embodiment of the computer-implemented system for communicating with select group(s) of users A computer-implemented method for communicating with select group(s) of users including executing the steps of providing a network, a database, a server running a business rules engine, the server communicating with the database, at least one first computer apparatus having a display and a network connection to communicate with the server, at least one second computer apparatus having a display and a network connection to communicate with the server and a notification server configured to enable a plurality of communications between users, the users including one or more service providers via the at least one first computer apparatus and one or more service requestors via the at least one second computer apparatus, and storage of the communication in the database, wherein the business rules engine is configured to enable searching of data files, searching service providers, searching the service requestor, to enable communicating between the service providers and the service requestors, and to enable selecting of the service provider and scheduling of a service to be performed by the service provider.

The system for communicating with select group(s) of users (hereinafter referred to as system) comprises, in general, a Graphical User Interface (GUI) that users utilize to interact with the system, a data layer where data provided to the system (input) by the users and data generated by the system (output) as a result of user interaction are stored therein a database, a Business Rules Engine (BRE) that applies various business rules to the input resulting from user interaction with the system and generates the output, and a Notification Service Layer (NSL) that the system uses to expedite communication from the system back to the users.

Smartphone applications (App) that are custom developed for multiple smartphone platforms, applications developed for multiple personal computer operating systems, or an Internet Web page provides the current User Interface between users and the system. Users utilize this interface to sign-up with the system, provide information about themselves like name, address/location, profile information, skills they have or services they'd like to provide other users of the system, and manage their communication preferences. The users also the use the interface to request new services from other users of the system, read and respond to communication they receive from other users of the system, and manage their privacy settings and privacy options. The user interface can also be used for supplemental activities like rating another user's skills/service, share information about the system with their friends and contacts, and provide feedback to the system administrators, and also to sign out of the system.

The primary purpose of this system is to connect users who request a service with other users who provide such a service. All users of the system are encouraged to list their skills, or services they can provide. Everyone has some skills or service, and the system envisions building a community of service providers from amongst its users, who in turn will also become consumers of services from other users registered with the system. If a user has no skill or service to provide, the user can select something as like ‘Volunteer’ as their skill/service, and the users can also choose not to receive any service requests for their skills or service.

When a user of the system is looking for a service provider or someone with a particular skill, the user first goes to the ‘Home’ page of the App, or to the web interface. Here the user can enter the skill/service he is looking for in the space provided for that purpose. The user can then pick the search radius from the Range Selector, and also choose to search around his current location, or around his home location. The user then enters a short description of the specific details of the service he's looking for in the space provided. Once all the information is provided, the user then clicks the “SEND” button. At this point, the system will automatically send notification to all other users who have listed the requested skill/service as one of the skills/services they provide, and whose location/address falls within the search radius selected by the requester. In order to protect the privacy of the users and to prevent unnecessary clutter in the ‘Inbox’, the requester will not see the list of the recipients, unless a recipient chooses to reply to the request. Once a service provider replies, a direct communication link is established between the service requestor and the service provider. At this point, the requestor and the provider can communicate further details of the service request and delivery privately through the system. Multiple service providers will reply to a request, thereby increasing the options available for the requestor and reducing his cost.

Once a request is made by a user through the User Interface, that request is conveyed back to the data layer of the system. Currently, the data layer of the system resides in a Relational Database (RDBMS). There are multiple tables within the RDBMS that store the user input data required for the efficient functioning of the system. In the future, the data layer might change to something more powerful and nimble than a relational database system, depending on the load on the system, and response times desired.

All the input data that reaches the data layer of the system passes through the Business Rules Engine (BRE). Any part of the system that acts on the input data to manipulate it and/or generate any output data is collectively called the BRE. Currently, the BRE of this system comprises database stored procedures, PHP pages, and object oriented programming procedures. The most important function of the BRE is to generate the list of the provider users to be notified of an incoming service request, in a timely manner. The BRE also manages user accounts, facilitates private communication between users once a private communication channel is established and enables addition, modification, activation and de-activation of skills/services by users. Another important function of the BRE is to manage users' privacy options, including message/chat delete from other users' devices as part of safeguarding user privacy. The BRE also provides the list of recipients to the Notification Service Layer.

The Notification Service Layer (NSL) ensures timely outbound communication between the system and the User Interface used by the users. Currently, NSL consists of Apple Push Notification Service (APNS), Google Cloud Messaging (GCM), and Windows Push Notification, each service catering to its namesake Smartphone platform. The notifications received by NSL from the BRE are pushed to the appropriate recipient user device by the above mentioned services. In the future, third party notification services might be used for better scalability. The User Interface can communicate directly with the system backend to receive output data without using notification services. But that would require constant polling of the backend server by the User Interface, which will cause unnecessary load on both User Interface and the system's back-end servers resulting in diminished performance.

Alternate embodiments that offer reduced functionality than what is offered by the present disclosure already exist in the market. The biggest difference between alternate embodiments and the present disclosure is the absence of a central gatekeeping authority that controls the list of service providers in those embodiments. The present disclosure represents a platform or system for every user to register their skills/services and actively take part in the ecosystem as both service requesters and service providers. The barrier to entry for a service provider is non-existent in the present disclosure, thus reducing the cost of service for all the users of the system.

Accordingly, a feature of the system and computer-implemented method for communicating with select group(s) of users is the ability to bring about a paradigm shift in how the service market place functions worldwide by enabling a service provider now knows exactly when a service requestor needs a service, and a service requestor can communicate directly with all possible service providers that can fulfil their needs.

Another feature of the system and computer-implemented method for communicating with select group(s) of users is its ability to reduce the cost of providing services by reducing the cost to find leads and prospective clients.

Still another feature of the system and computer-implemented method for communicating with select group(s) of users is its ability to reduce the time and effort required to reach out and get a response from the service providers.

Yet another feature of the system and computer-implemented method for communicating with select group(s) of users is its ability to enable communication between service providers and service requestors, selection of a service provider, scheduling of service to be provided by a service provider.

Yet another feature of the system and computer-implemented method for communicating with select group(s) of users is its ability to enable communication between service providers and service requestors, termination of communication, and deleting all communication from computer apparatus of both service provider and service requestor.

Yet another feature of the system and computer-implemented method for communicating with select group(s) of users is its ability to enable addition of a skill by a service provider, communications between service provider and service requestor regarding the skill, deletion of the skill, and deleting all communication from computer apparatus of both service provider and service requestor. Yet another feature of the system and computer-implemented method for communicating with select group(s) of users is its ability to enable addition of a service request by a service requestor, communications between service provider and service requestor regarding the service request, deletion of the service request, and deleting all communication from computer apparatus of both service provider and service requestor.

Yet another feature of the system and computer-implemented method for communicating with select group(s) of users is its ability to bring about a paradigm shift in how the service market place functions worldwide. Currently, service providers typically conduct mass marketing efforts like newspaper ads, radio and TV ads, postal inserts, fliers, etc. These kind of marketing efforts increases the cost of providing services, and do not necessarily guarantee that their marketing message reaches the customer who is looking for a particular service at the time when the customer is looking for the service. On the other hand, a customer who needs a service still has to perform a traditional search for service providers in Yellow Pages, Angie's List, Yelp, CareerBuilder, etc. and spend unnecessary time and effort trying to reach out and get a response from the service providers.

Yet another feature of the system and computer-implemented method for communicating with select group(s) of users is its ability to enable a new paradigm by using the features of the present disclosure (system), a notification is sent to all the service providers (selected based on various criteria) when a customer requests a service. The service provider can pointedly reach out to the service requestor through the system based on the requestor's specific needs. The onus to reach out to the requestor is on the provider, rather than the other way around in the current service market place. The service provider, on the other hand, gains by saving on mass marketing expenses, and knows exactly when a requestor needs a service and what service he needs. This enables the provider to pass on the marketing savings to the customer, in the form of a discount, etc.

Yet another feature of the system and computer-implemented method for communicating with select group(s) of users is its ability to increase the overall efficiency of the service market place by increasing competition among service providers. The present disclosure increases the competition by lowering the barrier to entry into the service marketplace for non-established players. Using this system, any service provider with the right skill can compete on price and skill level rather than on their marketing prowess. The ease of using the system, and the lower barrier to entry will encourage part time service providers to participate in the service marketplace akin to Uber/Lyft, but not limited to providing just logistical services like Uber/Lyft.

Yet another feature of the system and computer-implemented method for communicating with select group(s) of users is its ability to enable the service requestor to send his request notification to a pre-determined number of active service providers by progressively increasing the search radius for the skill/service until the pre-set or determined number of providers is notified. This guarantees that the requestor gets a response from a large enough pool of providers to enable a competitive search of the marketplace.

Yet another feature of the system and computer-implemented method for communicating with select group(s) of users is its ability to enable Nationwide Search. This feature of the present disclosure allows the requestors of certain soft skills (eg., software development, consulting, graphics design, etc.) to send the request to all the active service providers in the requester's country who have listed the desired skill/service. This feature guarantees that requestors who are looking for extremely hard to come by skill/service can reach a wider audience than local or regional search, thus increasing the requestor's chance of finding a willing and qualified provider.

Yet another feature of the system and computer-implemented method for communicating with select group(s) of users is its ability to enable as Auto Range feature for automatic nationwide search for skills/services for which nationwide search is enabled. For such soft skills, an auto range search will progressively increase the search radius without any distance limit until either the pre-determined number of service providers are notified, or all the service providers within the requestor's country are notified.

Yet another feature of the system and computer-implemented method for communicating with select group(s) of users is its ability to enable Search Pivot Selection. This feature of the present disclosure provides a service requestor with the flexibility to search around his current phone location, his home location, or any other location that is added to the user's profile. For example, by using home location feature, the user can search for service providers like electricians, plumbers, etc. for his home while he is at his office. By using the current location feature, the user can search for service providers like auto mechanics, towing service, etc. around his current location if he is on the road. Using this feature, a user can also search for service providers around a secondary location like a vacation home, etc.

Yet another feature of the system and computer-implemented method for communicating with select group(s) of users is its ability to enable Time-bucketed Service Request Notification. This feature of the present disclosure allows service providers to get faster notification of service requests by subscribing to premium services. All the active service providers in the system will eventually be notified of a service request, but time-bucketed service notification will allow premium subscribers to gain a competitive advantage by getting request notifications sooner than non-premium subscribers. This feature can be extended to add multiple tiers of premium subscriptions with different time lags between the receipt of a service request, and its notification to service providers.

Yet another feature of the system and computer-implemented method for communicating with select group(s) of users is its ability to enable Color Coded Message Threads. The present disclosure represents a platform or system where every user can register their skills/services and actively take part in the ecosystem as both service requestors and service providers. This represents a two-way street where a user can be a service requestor and a service provider at the same time. In order to distinguish between service requests initiated by the user, and service notifications received by the user, the message/chat threads for each type of communication (initiator v/s recipient) are differentiated with easily identifiable colors in the User Interface.

Yet another feature of the system and computer-implemented method for communicating with select group(s) of users is its ability to enable Activate/De-activate Skills. As mentioned above, the present disclosure works on the principle that every user is a service provider and a service recipient. However, there could be situations where a user is unable or unwilling to provide a service for which he has the skill. Such users may not wish to receive service notifications for one or more skills listed. In such cases, a user can list a skill and de-activate it in the system. De-activation of a skill will prevent new service request notifications from reaching the user, while at the same time, that skill will still be listed in the user's profile. This will allow service requestors to evaluate the overall skill of a provider before deciding on utilizing a provider's services. At the same time, listing too many unrelated services on a user's profile, whether active or inactive, could serve as a red flag for the requestor about a service provider's intentions.

A de-activated skill can be re-activated any time by the user. The user will start receiving relevant service request notifications as soon as a skill is reactivated.

Retro-active Notification: Any user of the present disclosure who is adding a new skill, be it a new user signing up with a new skill or an existing user adding a new skill, will get notified of all the service requests originated within a pre-determined period of time, if the user's new skill is eligible to get notified based on the search radius requested in the service origination request. This feature allows the new service providers signing up with the disclosure to start using their skills/services right away on existing requests.

By the same token, if a user deletes a skill, then all the service requests he has received for that skill will be deleted from his User Interface, and the user will not be able to reply to such service requests.

Yet another feature of the system and computer-implemented method for communicating with select group(s) of users is its ability to enable Skill Specific Rating. This feature of the present disclosure allows users to rate each specific skill/service that a service provider has listed. The service requestor may be able to see the skill specific rating of the provider in the provider's profile, which will help the requestor in selecting the best service provider to suit his needs. The system will also calculate and display an overall service provider rating based on the skill specific rating that the provider has received.

Yet another feature of the system and computer-implemented method for communicating with select group(s) of users is its ability to enable Advanced Privacy Features. There are several novel and unique privacy features that are implemented in the present disclosure to ensure the privacy of the users and the efficacy of the system.

An important privacy feature is the ability of a user to delete his requests, messages, and chats from the User Interface (smartphone App, web page, etc.) of another user that the first user has been communicating with. This will automatically prevent any further communication between the two users on that request/message thread. This feature is important because the system puts two unrelated users into contact with each other as a service requestor and a service provider. This feature allows either user, service requestor and a service provider, to cut off contact with the other party by simply deleting the other party's request/message thread from his own phone, which will in turn delete the messages from the other party's phone as well. This feature can also be used by a service requestor if his need has been met, and does not wish to receive any more replies for his request.

Another privacy feature is enforced at the time of sending a service request by any user. When a user sends a service request, the system automatically notifies the service providers based on the rules for the request. However, in order to protect the privacy of the users and to prevent unnecessary clutter in system, the requestor does not see the list of the recipients, unless a recipient chooses to reply to the request.

One-click Information Sharing: This feature of the present disclosure allows users to share their contact information including their address, phone number, etc. with another user using a simple, single-click functionality. This feature comes in handy when a service requestor has to share his information with a service provider or vice-versa, once a match has been made. Simplified Payment Process: The present disclosure has tie-in with existing payment facilitators like PayPal, Square, credit card issuers, etc. to enable seamless payment for services received through the system.

These and other features of the system and computer-implemented method for communicating with select group(s) will become more apparent to one skilled in the art from the following Detailed Description of exemplary embodiments and Claims when read in light of the accompanying drawing Figures.

### BRIEF DESCRIPTION OF THE DRAWINGS

The present system and computer-implemented method for communicating with select group(s) will be better understood by reading the Detailed Description of exemplary embodiments with reference to the accompanying drawing figures, in which like reference numerals denote similar structure and refer to like elements throughout, and in which:

FIG. 1 is a block diagram of a computer system of the present disclosure;

FIGS. 2, 2A, 2B is a block diagram of a communications system implemented by the computer system in FIG. 1;

FIG. 3 is an exemplary embodiment of a block or flow diagram of the functionality to add a new skill to a user profile utilizing the present system and computer-implemented method for communicating with select group(s) via computer systems in FIGS. 1 and 2;

FIG. 4A is another exemplary embodiment of a graphical user interface (GUI) displayed on user of the functionality to create an account by a new user of the system shown in FIGS. 1 and 2;

FIG. 4B is an exemplary embodiment of a graphical user interface (GUI) displayed on user 220 of the functionality to add a new skill to a user profile utilizing the present system and computer-implemented method for communicating with select group(s) via computer systems in FIGS. 1 and 2;

FIG. 5 is another exemplary embodiment of a graphical user interface (GUI) displayed on user 220 adding a new skill shown in FIG. 3;

FIG. 6 is an exemplary embodiment of a block or flow diagram of the functionality to delete a new skill from a user profile utilizing the present system and computer-implemented method for communicating with select group(s) via computer systems in FIGS. 1 and 2;

FIG. 7 is an exemplary embodiment of a graphical user interface (GUI) displayed on user 220 of deleting a new skill from a user profile, as shown in FIG. 6;

FIGS. 8 and 9 are an exemplary embodiment of a block or flow diagram of the functionality of adding a new Service Request utilizing the present system and computer-implemented method for communicating with select group(s) via computer systems in FIGS. 1 and 2;

FIG. 10 is an exemplary embodiment of a graphical user interface (GUI) displayed on user 220 of adding a new Service Request, as shown in FIGS. 8 and 9;

FIGS. 11 and 12 are an exemplary embodiment of a block or flow diagram of the functionality of closing a Service Request utilizing the present system and computer-implemented method for communicating with select group(s) via computer systems in FIGS. 1 and 2;

FIG. 13 is an exemplary embodiment of a graphical user interface (GUI) displayed on user 220 of closing a Service Request, as shown in FIGS. 11 and 12;

FIGS. 14 and 15 are an exemplary embodiment of a block or flow diagram of the functionality of deleting a Communication Thread utilizing the present system and computer-implemented method for communicating with select group(s) via computer systems in FIGS. 1 and 2;

FIG. 16 is an exemplary embodiment of a graphical user interface (GUI) displayed on users 220 of deleting a Communication Thread, as shown in FIGS. 14 and 15;

FIG. 17 is an exemplary embodiment of a block or flow diagram of the functionality of joining a new group utilizing the present system and computer-implemented method for communicating with select group(s) via computer systems in FIGS. 1 and 2;

FIG. 18 is an exemplary embodiment of a graphical user interface (GUI) displayed on users 220 of joining a new group, as shown in FIG. 17;

FIG. 19 is an exemplary embodiment of a block or flow diagram of the functionality of leaving an existing group utilizing the present system and computer-implemented method for communicating with select group(s) via computer systems in FIGS. 1 and 2;

FIG. 20 is an exemplary embodiment of a graphical user interface (GUI) displayed on users 220 of leaving an existing group, as shown in FIG. 19;

FIGS. 21 and 22 are an exemplary embodiment of a block or flow diagram of the functionality of deleting a message to a group utilizing the present system and computer-implemented method for communicating with select group(s) via computer systems in FIGS. 1 and 2; and

FIG. 23 is an exemplary embodiment of a graphical user interface (GUI) displayed on users 220 of deleting a message to a group, as shown in FIGS. 21 and 22.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

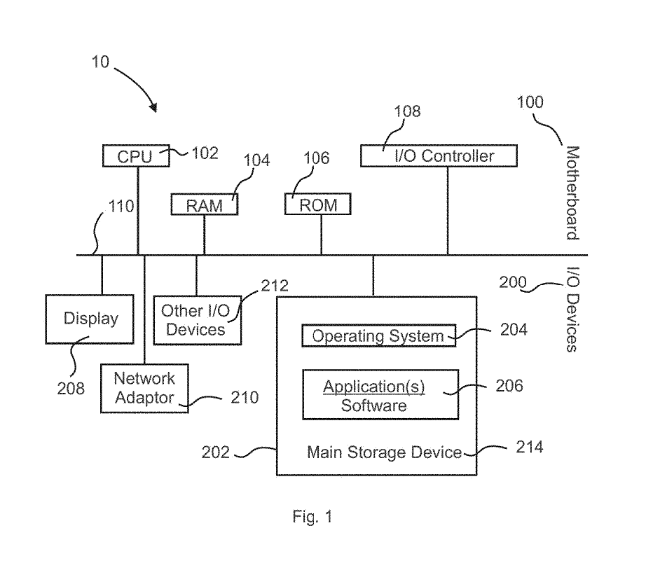

In describing the exemplary embodiments of the present disclosure, as illustrated in FIGS. 1-23, specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples, and are merely examples among other possible examples.

As will be appreciated by one of skill in the art, the present disclosure may be embodied as a method, data processing system, or computer program product. Accordingly, the present disclosure may take the form of an entirely hardware embodiment, entirely software embodiment or an embodiment combining software and hardware aspects. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like.

The present disclosure is described below with reference to flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations. These computer program instructions or operations may be loaded onto a general purpose computer, special purpose computer, or other programmable data processing apparatus to produce a machine, such that the instructions or operations, which execute on the computer or other programmable data processing apparatus, create means for implementing the functions specified in the flowchart block or blocks/step or steps.

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps.

Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions or operations.

Computer programming for implementing the present disclosure may be written in various programming languages, database languages, and the like. However, it is understood that other source or object oriented programming languages, and other conventional programming language may be utilized without departing from the spirit and intent of the present disclosure.

User Interface, such as a multitude of graphical user interface (GUI), may be utilized and presented to a service provider(s) and service requestor(s), collectively user(s) to capture, store, and display user information UI such as contact information (name, address, city, state, country, postal code, telephone, email, social media accounts), user' skill or service offered, user skill or service desired and the like, enable functionality to utilize the system, such as sign up, create an account, login via a user name and password, retrieve a lost user name and/or password, agree to terms and conditions, add profiles, pictures, videos, comments, submit contact information, write reviews, select a star rating, search for service providers, display service provider information, map service providers, map service requestor, enable payments for retainers and completed services, enable map driving directions to service provider and service requestor, enable messaging between users, and output information from system 201.

Referring now to FIG. 1, there is illustrated a block diagram of a computer system 10 that provides a suitable environment for implementing embodiments of the present disclosure. The computer architecture shown in FIG. 1 is divided into two parts—motherboard 100 and the input/output (I/O) devices 200. Motherboard 100 preferably includes subsystems or processor to execute instructions such as central processing unit (CPU) 102, a memory device, such as random access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computer system 10 further preferably includes I/O devices 202, such as main storage device 214 for storing operating system 204 and instructions or application program(s) 206, and display 208 for visual output, and other I/O devices 212 as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104.

Many other devices or subsystems or other I/O devices 212 may be connected in a similar manner, including but not limited to, devices such as global positioning system (GPS), microphone, speakers, flash drive, CD-ROM player, DVD player, printer, main storage device 214, such as hard drive, and/or modem each connected via an I/O adapter. Also, although preferred, it is not necessary for all of the devices shown in FIG. 1 to be present to practice the present disclosure, as discussed below. Furthermore, the devices and subsystems may be interconnected in different configurations from that shown in FIG. 1, or may be based on optical or gate arrays, or some combination of these elements that is capable of responding to and executing instructions or operations. The operation of a computer system such as that shown in FIG. 1 is readily known in the art and is not discussed in further detail in this application, so as not to overcomplicate the present discussion.

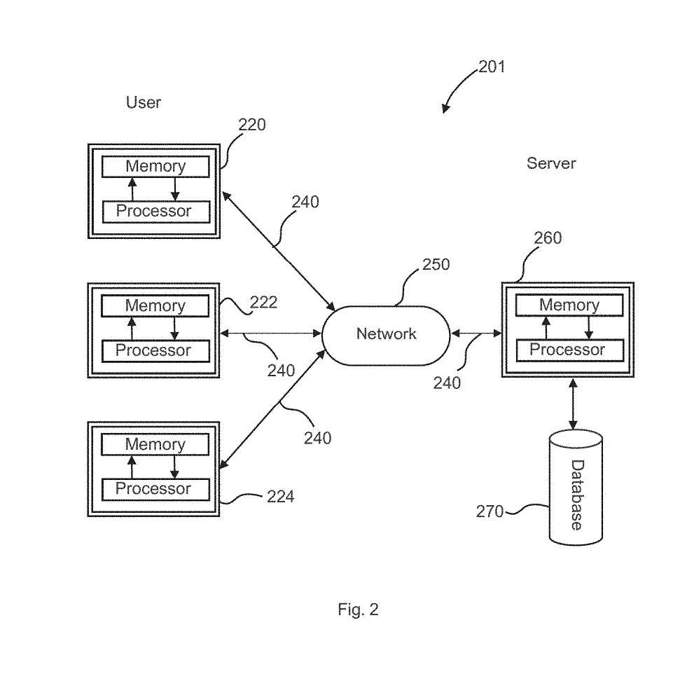

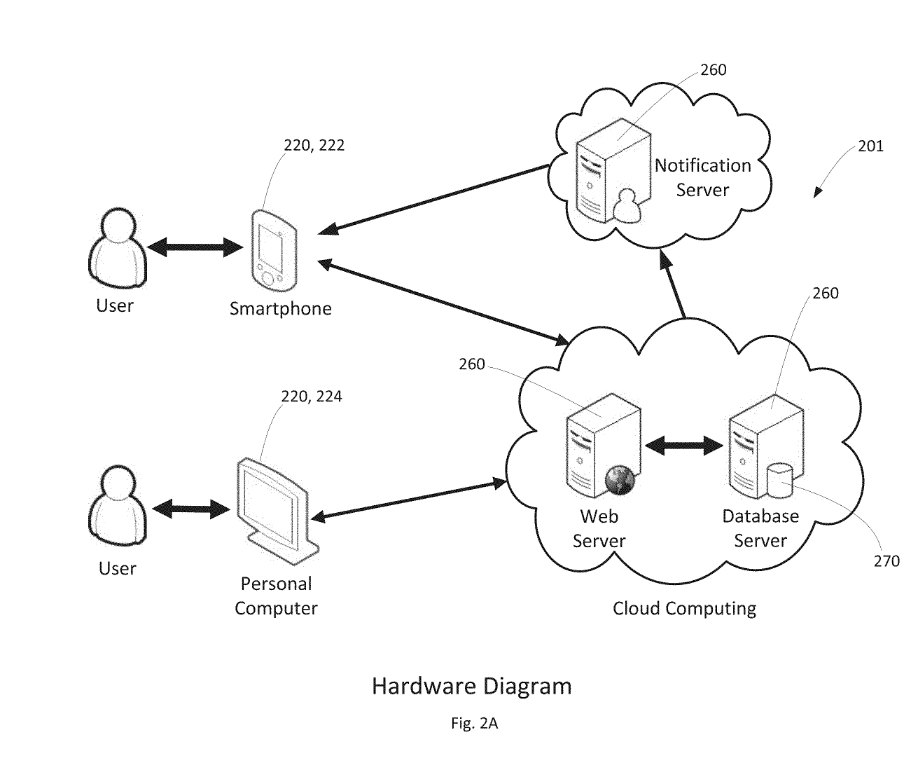

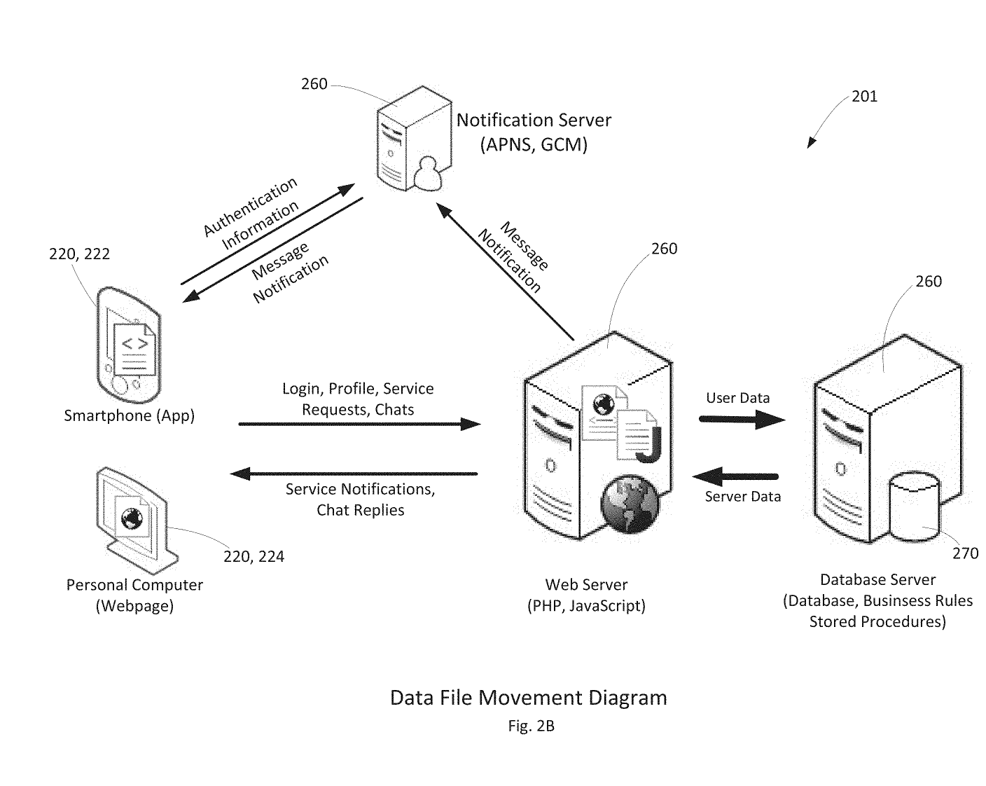

Referring now to FIGS. 2, 2A, 2B there is illustrated a diagram depicting an exemplary communication system 201 in which concepts consistent with the present disclosure may be implemented. Examples of each element within the communication system 201 of FIG. 2 are broadly described above with respect to FIG. 1. In particular, the server system 260 and user system 220 have attributes similar to computer system 10 of FIG. 1 and illustrate one possible implementation of computer system 10. Communication system 201 preferably includes one or more user systems 220, 222, 224, one or more server system 260, and network 250, which could be, for example, the Internet, public network, private network or cloud. User systems 220-224 each preferably include a computer-readable medium, such as random access memory, coupled to a processor. The processor, CPU 102, executes program instructions or operations stored in memory. Communication system 201 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a digital camera, a component, other equipment, or some combination of these elements that is capable of responding to and executing instructions or operations.

Similar to user system 220, server system 260 preferably includes a computer-readable medium, such as random access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains one or more executable steps, program(s), algorithm(s), or application(s) 206 (shown in FIG. 1). For example, the server system 260 may include a web server, information server, application server, one or more general-purpose computers (e.g., personal computers), one or more special purpose computers (e.g., devices specifically programmed to communicate with each other), a workstation or other equipment, or some combination of these elements that is capable of responding to and executing instructions or operations.

Communications system 201 is capable of delivering and exchanging user information UI between user system 220 and a server system 260 through communications link 240 and/or network 250. Through user system 220, users can preferably communicate over network 250 with each other user system 220, 222, 224, and with other systems and devices, such as server system 260, to electronically transmit, input, output, store, print and/or view user information UI. Communications link 240 typically includes network 250 making a direct or indirect communication between the user system 220 and the server system 260, irrespective of physical separation. Examples of a network 250 include the Internet, cloud, analog or digital wired and wireless networks, radio, television, cable, satellite, and/or any other delivery mechanism for carrying and/or transmitting data or other information, such as to electronically transmit, store, print and/or view information UI. The communications link 240 may include, for example, a wired, wireless, cable, optical or satellite communication system or other pathway.

It is contemplated herein that RAM 104, main storage device 214, and database 270 may be referred to herein as storage device(s) or memory device(s).

The Business Rules Engine (BRE) resides with database server 260, which acts on the user 220 input data to manipulate it and/or generate any output or server data communicated between database server 260 and web server 260. Web server 260 communicates with notification server 260 delivering message notification thereto notification server 260 and communicates with users 220 receiving information such as, login, profile, service requests, chats and the like and delivering information, such as, service notifications, chat replies and the like. All the input data that reaches the data layer of system passes through the Business Rules Engine (BRE) operating thereon database server 260. Currently, the BRE of system 201 comprises database 270 stored procedures, PHP pages, and object oriented programming procedures. One function of the database server 260 via BRE is to generate the list of the service provider users 220 to be notified of an incoming service request, in a timely manner. Moreover, database server 260 via BRE also manages user accounts, facilitates private communication between users once a private communication channel is established and enables addition, modification, activation and de-activation of skills/services by users. Another function of database server 260 via BRE is to manage users' privacy options, including message/chat delete from other users' devices as part of safeguarding user privacy. The database server 260 via BRE also provides the list of recipients to the Notification Service Layer.

The Notification Service Layer (NSL) resides with notification server 260, which ensures timely outbound communication between the system and the User Interface used by the users 220. Currently, NSL consists of Apple Push Notification Service (APNS), Google Cloud Messaging (GCM), and Windows Push Notification, each service catering to its namesake Smartphone platform. The notifications received by NSL from the BRE are pushed to the appropriate recipient user device by the above mentioned services. In the future, third party notification services might be used for better scalability. The User Interface can communicate directly with the system backend to receive output data without using notification services. But that would require constant polling of the backend server by the User Interface, which will cause unnecessary load on both User Interface and the system's back-end servers resulting in diminished performance.

The Notification Service Layer (NSL) resides with notification server 260, which ensures timely outbound communication between the system and the User Interface used by the users 220.

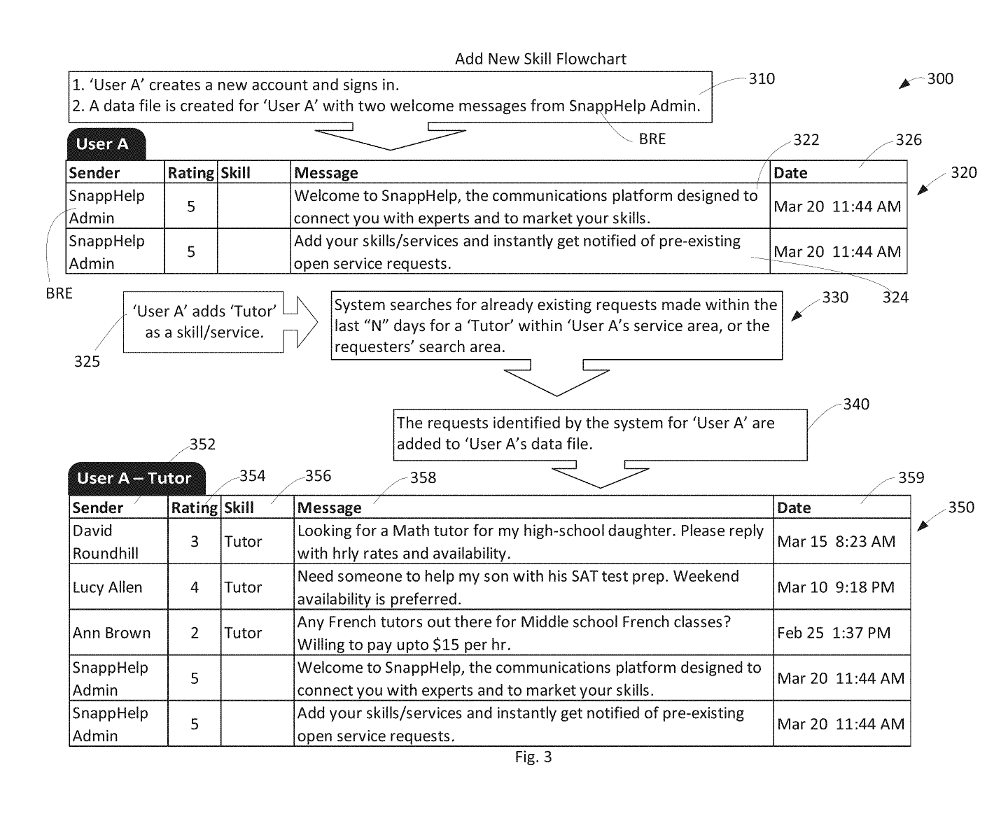

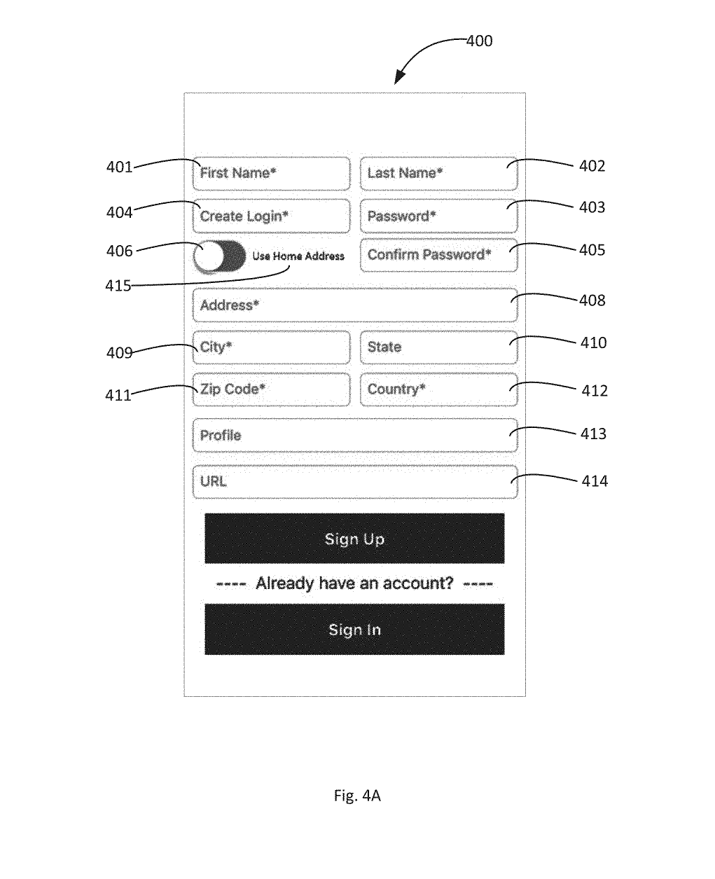

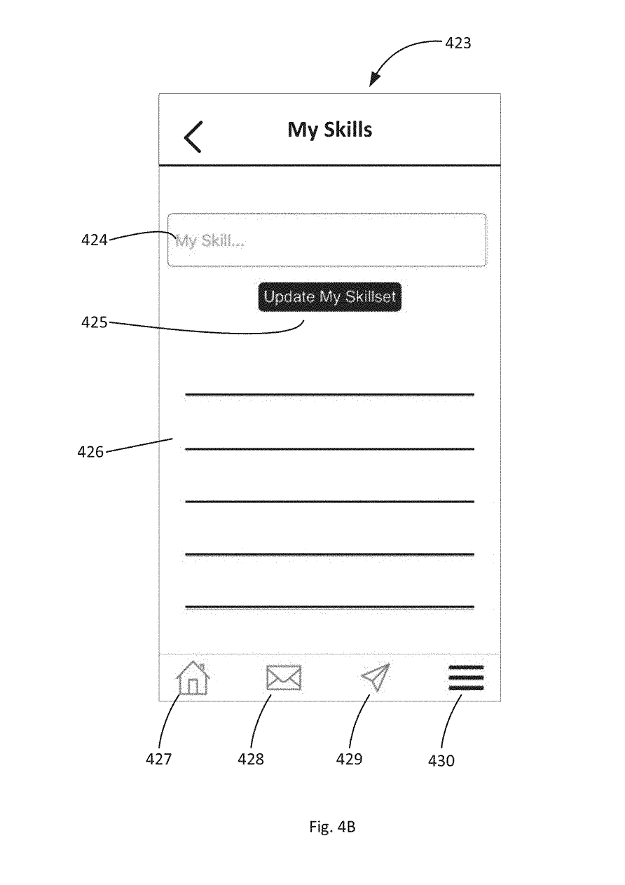

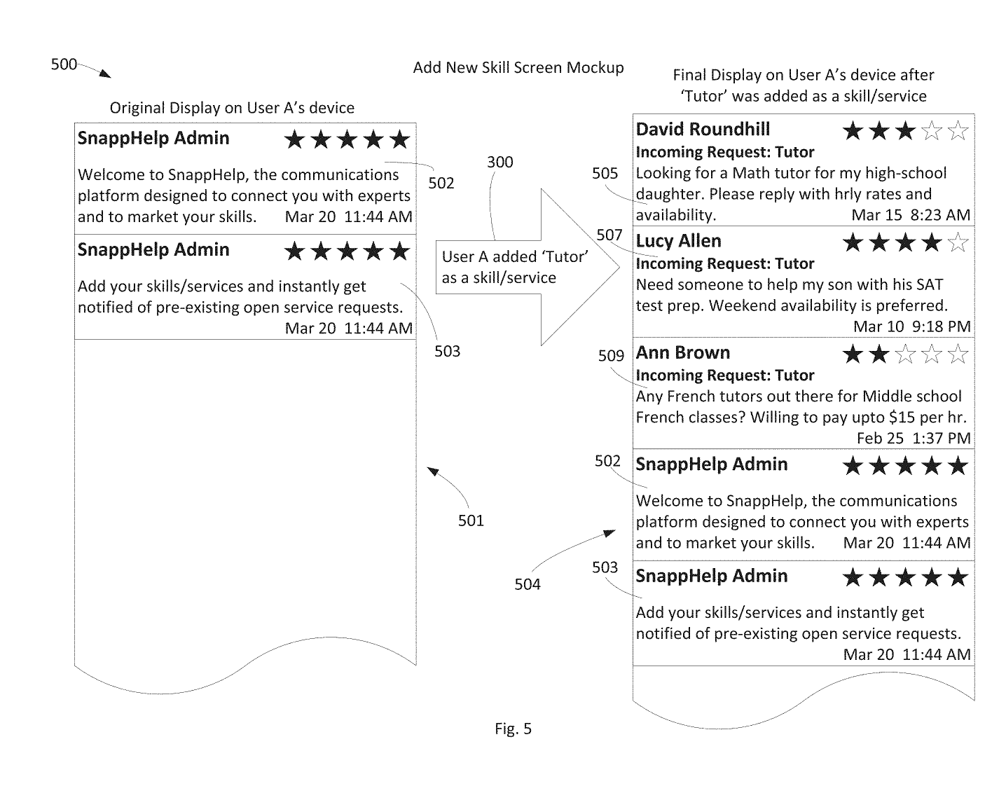

Referring now to FIGS. 3 and 5, by way of example, and not limitation, there is illustrated a block diagram and flow chart 300 of an exemplary embodiment of user 220 adding or add a new skill or service via system and computer-implemented method 201 for communicating with select group(s) of users 220. In block or step 310, user 220 creates a new account and signs in to system and computer-implemented method 201 for communicating with select group(s) of users 220, as shown in FIG. 4A. Referring now to FIG. 4A, by way of example, and not limitation, there is illustrated graphical user interface (GUI) displayed on display 208 of user 220 where user 220 may be presented with the ‘Sign Up’ screen 400. Sign Up screen 400, enables user 220 to sign up as user of system and computer-implemented method 201 for communicating with select group(s) of users 220 and more specifically, create a user account by providing user information UI, such as First Name 401, Last Name 402, Create Login 404, set Password 403, Confirm Password 404, slider switch 406 ((slider switch 406 may be positioned in its default position, the notation ‘Use Phone Location’ then Address 408, City 409, State 410, Zip Code 411 and Country 412 fields may be automatically populated with user 220 current location of user 220 (as determined by its internal GPS unit) as the home location for the user)). Otherwise, slider switch 406 may be positioned in ‘Use Home Address’ 415 where user may input Address 408, City 409, State 410, Zip Code 411 and Country 412 fields. Moreover, user 220 may provide Profile 413 information and an internet site URL 414, which will be visible to other users of system and computer-implemented method 201 for communicating with select group(s) of users 220.

Referring now to FIG. 4B, by way of example, and not limitation, there is illustrated graphical user interface (GUI) displayed on display 208 on user 220 where user 220 may be presented with the ‘My Skills’ screen 423. My Skills screen 423, enables enable users 220 who request a skill or service (service requestor) with other users 220 who provide such service (service providers). All users 220 are encouraged to list their skills or services they can provide to build a community of service providers from amongst its users 220, who in turn will also become consumers of services from other users 220 registered with the disclosure. To this end, until user 220 adds at least one skill or service, all users of the disclosure are presented with the ‘My Skills’ screen 423. Users 220, however, can bypass the ‘My Skills’ screen 423 and proceed directly to other screens of new skill or service via system and computer-implemented method 201 for communicating with select group(s) of users 220 the disclosure by pressing the Home 427, Inbox 428, Sent Requests 429, and Menu Options 430 buttons. More specifically, should user 220 choose to add a skill or service, user 220 may type a skill or service into the text box titled ‘My Skill . . . ’ 424. Once the user finishes typing a skill or service or selects a skill or service form a drop-down list, user 220 can press the ‘Update My Skillset’ button 425. All the skills or services that are successfully added for user 220 will be listed in the Skills Display area 426.

Web server 260 receives information from user 220 and communicates same to Business Rules Engine (BRE) residing with database server 260, which acts on the user 220 input data to manipulate it and/or generate any output. In block or step 330, web server 260 may communicate Business Rules Engine (BRE) generated output communication—Welcome Message 322, 324 to user 220, such as “Welcome to SnappHelp, the communications platform designed to connect you with experts and to market your skills” 322 at date time 326, such as “March 20 11:44 AM” and “Add your skills/services and instantly get notified of pre-existing open service requests” 324 to user 220.

Next, in block or step 325, user 220 may add a skill/service as a service provider, such as ‘User A’ adds ‘Tutor’ as a skill/service. Web server 260 receives information from user 220 and communicates same to Business Rules Engine (BRE) residing with database server 260, which acts on the user 220 input data to manipulate it and/or generate any output. In block or step 330, Business Rules Engine (BRE) residing with database server 260 searches database 270 and identifies users 220 requesting skill/service as a service requestor having pre-existing and new communications relating to said skill and with additional parameters such as, time, location, and other like parameters (relating to the skill/service, skill communication), such as “System searches for pre-existing requests or communications made within the last “N” days for a ‘Tutor’ within ‘User A's service area, or the requesters’ search area” and adds such pre-existing and new skill/service communications to user 220 data file. In block or step 340, Business Rules Engine (BRE) residing with database server 260 communicates search results (users 220 requesting skill/service as a service requestor) to Web server 260 and Web server 260 communicates search results (users 220 requesting skill/service as a service requestor) to user 220, such as “‘User A’. In block or step 350, user 220, such as “‘User A’ receives one or more search results—three shown (users 220 requesting skill/service as a service requestor), such search results may include user Information UI, including Sender 352, Rating 354, Skill 356, Message 358, and Date 359. For example, Sender 352, such as “David Roundhill”, Rating 354, such as “3”, Skill 356, such as “Tutor”, Message 358, such as, “Looking for a Math tutor for my high-school daughter. Please reply with hrly rates and availability.” and Date 359, such as “March 15 8:23 AM.” Again, sender 352, such as “Lucy Allen”, Rating 354, such as “4”, Skill 356, such as “Tutor”, Message 358, such as, “Need someone to help my son with his SAT test prep. Weekend availability is preferred.” and Date 359, such as “March 10 9:18 PM.” Again, sender 352, such as “Ann Brown”, Rating 354, such as “2”, Skill 356, such as “Tutor”, Message 358, such as, “Any French tutors out there for Middle school French classes? Willing to pay up to $15 per hr.” and Date 359, such as “February 25 1:37 PM.”

It is contemplated herein that user 220 provider of skill/service as a service provider is immediately presented with users 220 (service requestor) who have previously sought such skill/service of service providers and going forward new users 220 seeking such skill/service will be presented to user 220 (service provider).

Referring now to FIG. 5, by way of example, and not limitation, there is illustrated user 220 display 208 displaying screen shots 500, the steps set forth in FIG. 3. Web server 260 communicates search results (users 220 requesting skill/service as a service requestor) to user 220, such as “‘User A’ as original Display 501 and Final Display 504. In block or step 502, user 220 display 208 displays “Welcome to SnappHelp, the communications platform designed to connect you with experts and to market your skills. March 20 11:44 AM.” In block or step 503, user 220 display 208 displays “Add your skills/services and instantly get notified of pre-existing open service requests. March 20 11:44 AM.”

Next, users 220, such as ‘User A’, receives communications regarding Service Request of user 220, such as “‘User A’ adding ‘Tutor’ as a skill/service offered. Next, users 220, such as ‘User A’ display 208 updates with user 220, as ‘user A’ Service Request information. Next, in block or step 505-509, user 220 added a skill/service as a service provider, such as “‘User A’ adds ‘Tutor’ as a skill/service and user 220 display 208 displays users 220 as service requestors in block or step 505 “David Roundhill Incoming Request: Tutor Looking for a Math tutor for my high-school daughter. Please reply with hrly rates and availability. March 15 8:23 AM;” in block or step 507 “Lucy Allen Incoming Request: Tutor Need someone to help my son with his SAT test prep. Weekend availability is preferred. March 10 9:18 PM;” in block or step 509 “Ann Brown Incoming Request: Tutor Any French tutors out there for Middle school French classes? Willing to pay up to $15 per hr. February 25 1:37 PM.”

It is contemplated herein that users 220 may add any variety of skill/service or select preselected skill/service as a service provider.

It is contemplated herein that computer-implemented method 201 for communicating with select group(s) of users 22 may enable users 220 to rate and review other users 220 as service providers and maintain an average rating for each users 220 as service provider.

It is still further contemplated herein that computer-implemented method 201 for communicating with select group(s) of users 220 may enable users 220 to focus or limit the geographical scope of users 220 as service providers displayed as potential service providers via phone location, range indicator, phone location, radius, adjustable map, and the like from local, to regional, to national to provide an adequate sample of users 220 as service providers. This guarantees that user 220 gets a response from enough providers to enable a competitive search of the marketplace. For example, user 220 can search for service providers like auto mechanics, towing service, etc. around his current location if he is on the road or around a secondary location like a vacation home.

It is still further contemplated herein that computer-implemented method 201 for communicating with select group(s) of users 220 may enable users 220 to chat via messaging regarding skill or service between user 220 as service requestor and users 220 as service provider. Computer-implemented method 201 stores all message threads and enables retrieval and response to any archived message.

It is still further contemplated herein that computer-implemented method 201 for communicating with select group(s) of users 220 may enable users 220 to schedule and/or pay for services between user 220 as service requestor and users 220 as service provider.

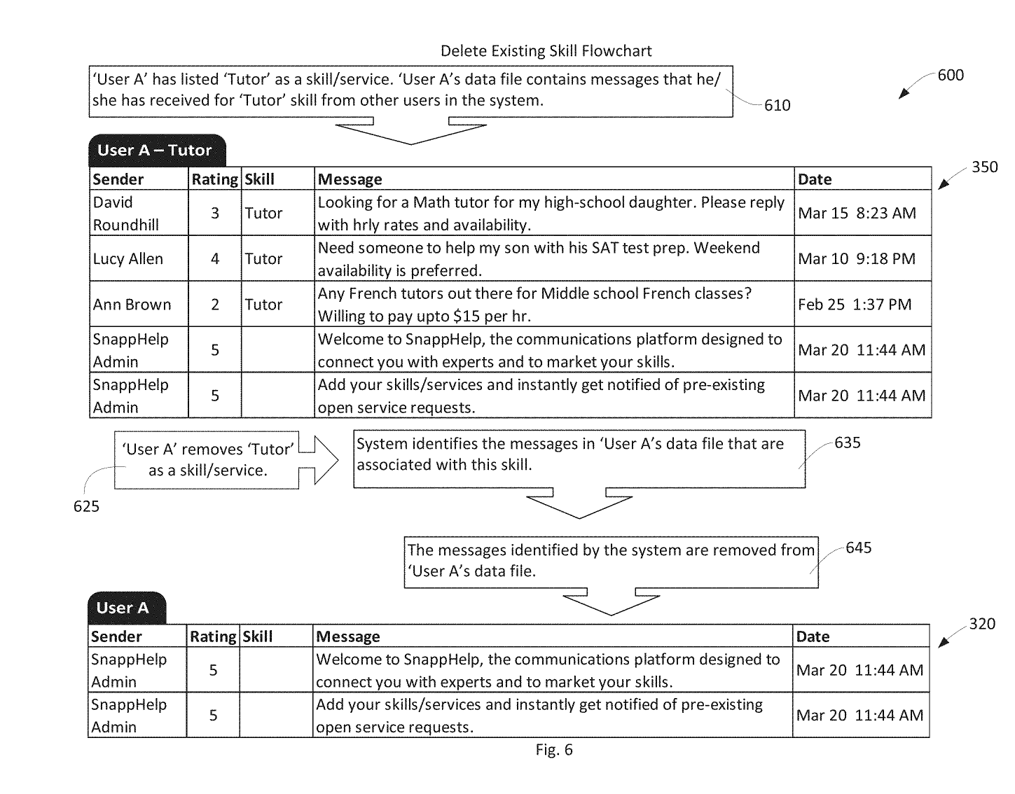

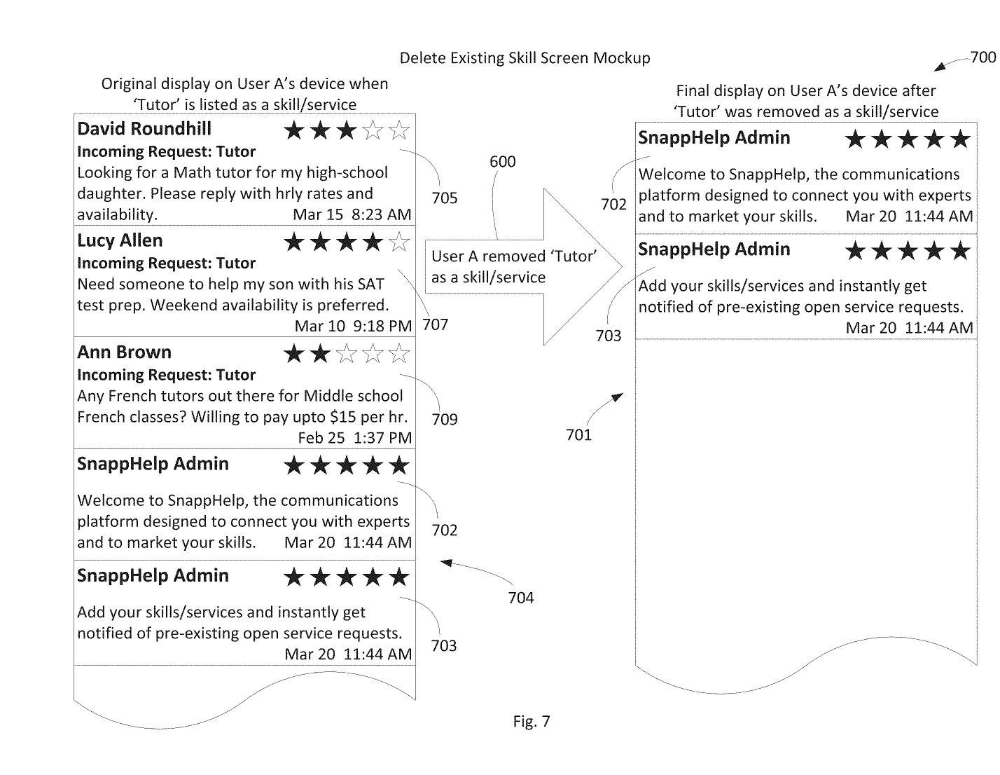

Referring now to FIGS. 6 and 7, by way of example, and not limitation, there is illustrated a block diagram and flow chart 600 of an exemplary embodiment of user 220 deleting a skill or service via system and computer-implemented method 201 for communicating with select group(s) of users 220. In block or step 610, user 220 such as ‘User A’ has listed ‘Tutor’ as a skill/service. User 220 such as ‘User A's data file contains messages that user 220 such as ‘User A’ has received for ‘Tutor’ skill from other users in the system. In block or step 625, user 220 may delete a skill/service as a service provider, such as “‘User A’ deletes ‘Tutor’ as a skill/service and communicate a delete action a skill/service as a service provider. Web server 260 receives information, a delete action of skill/service as service provider, from user 220 and communicates same to Business Rules Engine (BRE) residing with database server 260, which acts on the user 220 input data to manipulate it and/or generate any output.

In block or step 635, Business Rules Engine (BRE) residing with database server 260 searches and identifies all user 220 communications relating to skill/service of user 220, as ‘User A’ and ‘Tutor’ as a skill/service. Business Rules Engine (BRE) residing with database server 260 identifies three, such as Sender 352, such as “David Roundhill”, Rating 354, such as “3”, Skill 356, such as “Tutor”, Message 358, such as, “Looking for a Math tutor for my high-school daughter. Please reply with hrly rates and availability.” and Date 359, such as “March 15 8:23 AM.” Again, sender 352, such as “Lucy Allen”, Rating 354, such as “4”, Skill 356, such as “Tutor”, Message 358, such as, “Need someone to help my son with his SAT test prep. Weekend availability is preferred.” and Date 359, such as “March 10 9:18 PM.” Again, Sender 352, such as “Ann Brown”, Rating 354, such as “2”, Skill 356, such as “Tutor”, Message 358, such as, “Any French tutors out there for Middle school French classes? Willing to pay up to $15 per hr.” and Date 359, such as “February 25 1:37 PM.” and deletes communications relating to skill/service from user 220, as ‘User A’ and ‘Tutor’ as a skill/service from user 220, as ‘User A’ data file, delete skill data file for user 220, as ‘User A’.

In block or step 645, Business Rules Engine (BRE) residing with database server 260 communicates an action to web server 260 (notification server 260) to delete or remove therefrom user 220 all communications therefrom user 220, as ‘User A’ relating to ‘Tutor’ as a skill/service from display 208 of users 220, as ‘User A’ and from other users 220 system (delete skill data file) computer-implemented method 201 for communicating with select group(s) of users 220. Moreover, Business Rules Engine (BRE) residing with database server 260 communicates delete skill data file to user 220, as ‘User A’ display 208.

It is contemplated herein that all communications relating to ‘User A's skill/service as service provider or communication threads related to ‘User A's skill/service as service provider will be deleted from current user 220 as well as from user 220 that request skill/service as service provider, including all the back and forth communication that has resulted from skill/service as service provider.

Again in block or step 645, web server 260 may communicate Business Rules Engine (BRE) generated output communication to user 220 as ‘User A’ display 280—Welcome Message 322, 324 to user 220, such as “Welcome to SnappHelp, the communications platform designed to connect you with experts and to market your skills” 322 at date time 326, such as “March 20 11:44 AM” and “Add your skills/services and instantly get notified of pre-existing open service requests” 324 to user 220 as ‘User A’.

Referring now to FIG. 7, by way of example, and not limitation, there is illustrated user 220 display 208 displaying screen shots 700, the steps set forth in FIG. 6. Web server 260 displays communications between users 220 deleting skill/service as a service requestor to user 220, such as “‘User A’, shown on display 208 as original Display 704 and Final Display 701. In block or step 705-709, user 220 original display of users 220 requesting skill/service as a service requestor related to “‘User A’ adding ‘Tutor’ as a skill/service and user 220 display 208 displayed in block or step 705 “David Roundhill Incoming Request: Tutor Looking for a Math tutor for my high-school daughter. Please reply with hrly rates and availability. March 15 8:23 AM;” in block or step 707 “Lucy Allen Incoming Request: Tutor Need someone to help my son with his SAT test prep. Weekend availability is preferred. March 10 9:18 PM;” in block or step 709 “Ann Brown Incoming Request: Tutor Any French tutors out there for Middle school French classes? Willing to pay up to $15 per hr. February 25 1:37 PM.”

Next, in block or step 701, 702, system and computer-implemented method 201 deletes communications (delete skill data file) related user 220, as ‘User A’ and ‘Tutor’ as a skill/service from display 208 where all user 220 display 208 displays “Welcome to SnappHelp, the communications platform designed to connect you with experts and to market your skills. March 20 11:44 AM.” In block or step 703, user 220 display 208 displays “Add your skills/services and instantly get notified of pre-existing open service requests. March 20 11:44 AM.”

It is contemplated herein that computer-implemented method 201 for communicating with select group(s) of users 220 may delete prior notifications from users 220 display 208 via The Notification Service Layer (NSL) resides with notification server 260, which ensures timely outbound communication between the system and the User Interface used by the users 220. Currently, NSL consists of Apple Push Notification Service (APNS), Google Cloud Messaging (GCM), and Windows Push Notification, each service catering to its namesake Smartphone platform. The notifications received by NSL from the BRE are pushed to the appropriate recipient user device by the above mentioned services.

It is an object of the present disclosure to enable user 220, as ‘User A’ service provider of ‘Tutor’ as a skill/service to delete all communications regarding user 220, as ‘User A’ service provider of ‘Tutor’ from user 220, as ‘User A’ and all users 220 as service requestors.

It is further contemplated herein that computer-implemented method 201 for communicating with select group(s) of users 220 may delete any prior communications or notifications from other users 220 requesting a Skill/Service, that a user 220 has received by virtue of adding a Skill/Service thereafter by user 220 deleting a skill/service.

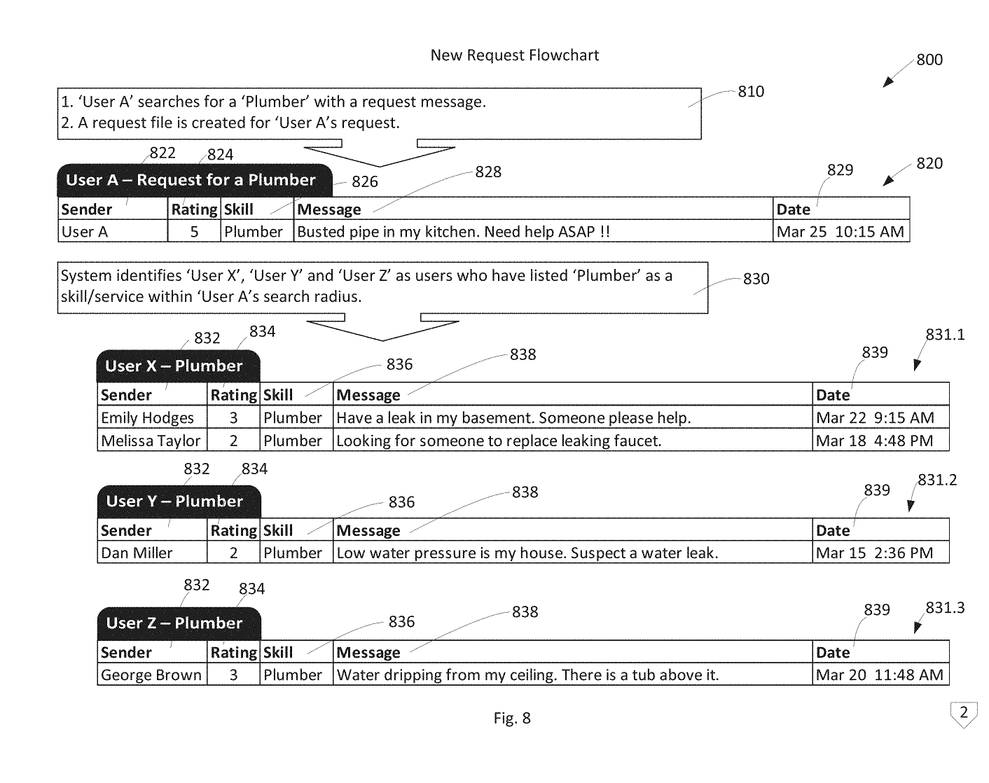

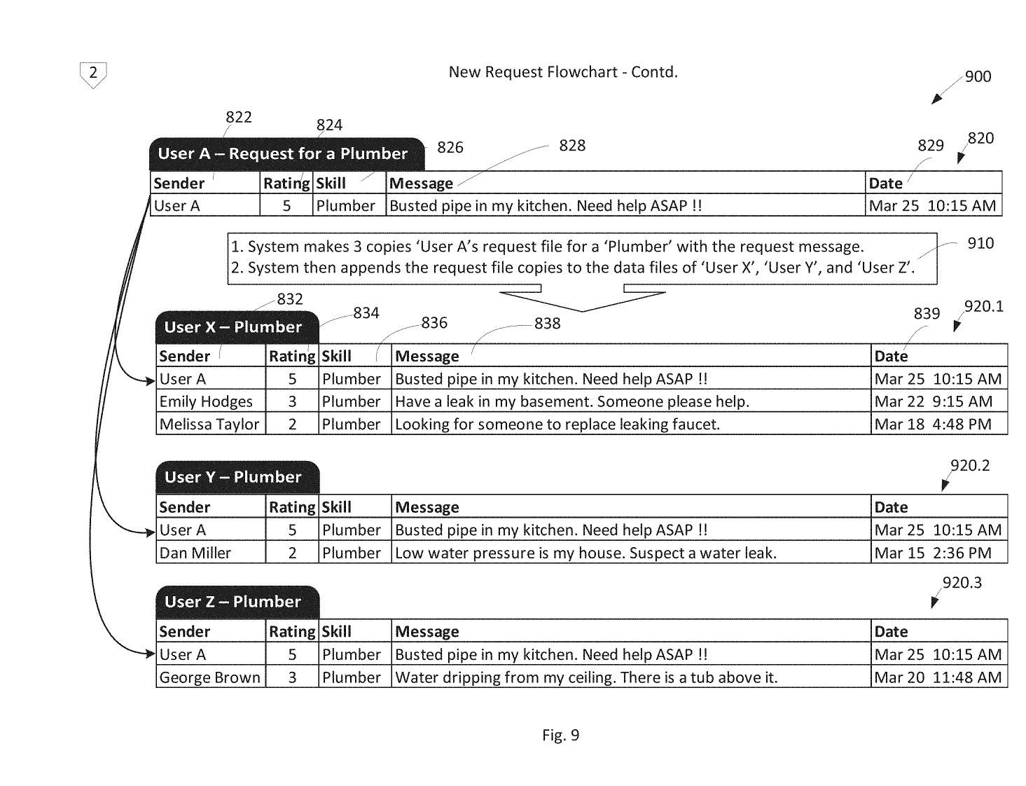

Referring now to FIGS. 8 and 9, by way of example, and not limitation, there is illustrated a block diagram and flow chart 800 of an exemplary embodiment of user 220, such as ‘User A’ service requestor requesting a new skill or service (Service Request) via system and computer-implemented method 201 for communicating with select group(s) of users 220. In block or step 810, user 220, such as “‘User A’ service requestor requesting a new skill or service, such as ‘Plumber’, (the, Service Request 810) and add to user 220, such as “‘User A’ service requestor data file, communication data file. In block or step 820, user 220, such as “‘User A’ inputs new skill or service, such as ‘Plumber’ Service Request information, including Sender 822, Rating 824, Skill 826, Message 828, and Date 829. For example, Sender 822, such as “User A’”, Rating 824, such as “5”, Skill 826, such as “Plumber”, Message 828, such as, “Busted pipe in my kitchen. Need help ASAP!!” and Date 829, such as “March 25 10:15 AM” as User Information UI, (Service Request).

In block or step 830, web server 260 receives the new skill or service request, as Service Request from user 220 and communicates same to database server 260 where Business Rules Engine (BRE) residing with database server 260 acts on the user 220 request performing a database 260 search or query of users 220 data files. Business Rules Engine (BRE) of Database server 260 identifies or matches one or more users 220, such as ‘User X’, ‘User Y’ and ‘User Z’ as users 220 who have listed skill or service of ‘Plumber’, users 220 matching Service Request within ‘User A's search radius or other criteria. For example, in block or step 831.1 user 220, such as ‘User X’ with listed skill or service of ‘Plumber’ having User Information UI, such as Sender 832, such as “Emily Hodges” and “Melissa Taylor”, Rating 834, such as “3” and “2” respectively, Skill 836, such as “Plumber”, Message 838, such as, “Have a leak in my basement. Someone please help.” and “Looking for someone to replace leaking faucet.” and Date 839, such as “March 22 9:15 AM” and “March 18 4:48 PM”, respectively. In block or step 831.2, user 220, such as ‘User Y’ with listed skill or service of ‘Plumber’ having User Information UI, such as Sender 832, such as “Dan Miller”, Rating 834, such as “3”, Skill 836, such as “Plumber”, Message 838, such as, “Low water pressure is my house. Suspect a water leak.”, and Date 839, such “March 15 2:36 PM”. In block or step 831.3, user 220, such as ‘User Z’ with listed skill or service of ‘Plumber’ having User Information UI, such as Sender 832, such as “George Brown”, Rating 834, such as “3”, Skill 836, such as “Plumber”, Message 838, such as, “Water dripping from my ceiling. There is a tub above it.”, and Date 839, such “March 20 11:48 PM” and ads one or more users 220, such as ‘User X’, ‘User Y’ and ‘User Z’ matching the service request to a data file of user 220, ‘user A’, a service requestor or ads service request to a data file of each of one or more users 220, such as ‘User X’, ‘User Y’ and ‘User Z’ matching the service request, a service request data file.

In block or step 910, Business Rules Engine (BRE) residing with database server 260 communicates search results (users 220 requesting skill/service as a service requestor) to Web server 260 and Web server 260 communicates Service Request (users 220 requesting skill/service as a service requestor) to users 220 as service providers, User X’, ‘User Y’ and ‘User Z’. For example, Business Rules Engine (BRE) residing with database server 260 makes three copies of user 220, such as “‘User A’ User Information UI data file, such as ‘Plumber’ Service Request information, including Sender 822, Rating 824, Skill 826, Message 828, and Date 829 and distributes to users 220 as service providers, User X’, ‘User Y’ and ‘User Z’. For example, Sender 822, such as “User A’”, Rating 824, such as “5”, Skill 826, such as “Plumber”, Message 828, such as, “Busted pipe in my kitchen. Need help ASAP!!” and Date 829, such as “March 25 10:15 AM” as User Information UI; 2) appends the request file copies user 220, such as ‘User A’ User Information UI data file to the data files of ‘User X’, ‘User Y’, and ‘User Z’.

Again in block or step 910, Business Rules Engine (BRE) residing with database server 260 communicates search results (users 220 requesting skill/service as a service requestor) to Web server 260 and Web server 260 communicates Service Request (users 220 requesting skill/service as a service requestor) to users 220, such as User X′, ‘User Y’ and ‘User Z’ service providers. For example, Business Rules Engine (BRE) residing with database server 260, communicates ‘User A’ service requestor User Information UI of new skill or service, such as ‘Plumber’, (the, Service Request 810) to ‘User X’, ‘User Y’, and ‘User Z’.

For example, in block or step 920.1 user 220, such as ‘User X’ with listed skill or service of ‘Plumber’ having User Information UI, such as Sender 832 “User A’”, Rating 834, such as “5”, Skill 836, such as “Plumber”, Message 838, such as, “Busted pipe in my kitchen. Need help ASAP!!” and Date 839, such as “March 25 10:15 AM” as User Information UI; Sender 832, such as “Emily Hodges” and “Melissa Taylor”, Rating 834, such as “3” and “2” respectively, Skill 836, such as “Plumber”, Message 838, such as, “Have a leak in my basement. Someone please help.” and “Looking for someone to replace leaking faucet.” and Date 839, such as “March 22 9:15 AM” and “March 18 4:48 PM”.

In block or step 920.2, user 220, such as ‘User Y’ with listed skill or service of ‘Plumber’ having User Information UI, such as Sender 832 “User A’”, Rating 834, such as “5”, Skill 836, such as “Plumber”, Message 838, such as, “Busted pipe in my kitchen. Need help ASAP!!” and Date 839, such as “March 25 10:15 AM” as User Information UI; Sender 832, such as “Dan Miller”, Rating 834, such as “3”, Skill 836, such as “Plumber”, Message 838, such as, “Low water pressure is my house. Suspect a water leak.”, and Date 839, such “March 15 2:36 PM”.

In block or step 920.3, user 220, such as ‘User Z’ with listed skill or service of ‘Plumber’ having User Information UI, such as such as Sender 832 “User A’”, Rating 834, such as “5”, Skill 836, such as “Plumber”, Message 838, such as, “Busted pipe in my kitchen. Need help ASAP!!” and Date 839, such as “March 25 10:15 AM” as User Information UI; Sender 832, such as “George Brown”, Rating 834, such as “3”, Skill 836, such as “Plumber”, Message 838, such as, “Water dripping from my ceiling. There is a tub above it.”, and Date 839, such “March 20 11:48 PM”.

It is recognized herein that users 220 pairing between user 220, as ‘User A’ and user 220, as ‘User X’; user 220, as ‘User A’ and user 220, as ‘User Y’; and user 220, as ‘User A’ and user 220, as ‘User Z’ are not connected for communication on the basis of shared information such as phone number, e-mail, login information, or the like. Rather, Business Rules Engine (BRE) residing with database server 260 acts on the user 220 input data to manipulate it and/or generate any output communication and the connection between ‘User A’ and other users, such as users 220 ‘User X’, ‘User Y’ and ‘User Z’ are made solely on the basis of a skill/service or a group that ‘User X’, ‘User Y’ and ‘User Z’ belong to, and where users 220 ‘User X’, ‘User Y’ and ‘User Z’ have indicated the same skill/service which is searched by ‘User A’.

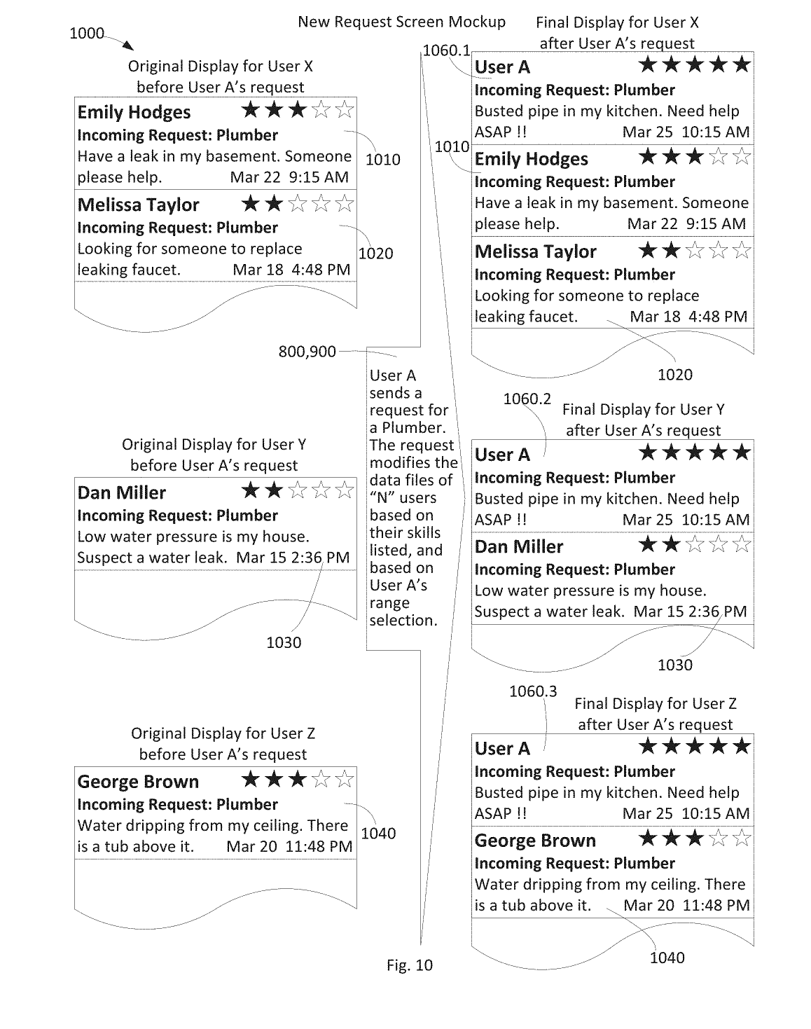

Referring now to FIG. 10, by way of example, and not limitation, there is illustrated user 220 display 208 displaying screen shots 1000, the steps set forth in FIGS. 8 and 9. Business Rules Engine (BRE) residing with database server 260 communicates search results (users 220 requesting skill/service as a service requestor) to Web server 260 and Web server 260 communicates search results (users 220 requesting skill/service as a service requestor) to users 220, such as ‘User X’, ‘User Y’ and ‘User Z’.

In block or step 1010, user 220 as ‘User X’ display 208 displays “Emily Hodges Incoming Request: Plumber Have a leak in my basement. Someone please help. March 22 9:15 AM”. In block or step 1020, user 220 as ‘User X’ display 208 displays “Melissa Taylor Incoming Request: Plumber Looking for someone to replace leaking faucet. March 18 4:48 PM”. In block or step 1030, user 220 as ‘User Y’ display 208 displays “Dan Miller Incoming Request: Plumber Low water pressure is my house. Suspect a water leak. March 15 2:36 PM”. In block or step 1040, user 220 as ‘User Z’ display 208 displays “George Brown Incoming Request: Plumber Water dripping from my ceiling. There is a tub above it. March 20 11:48 PM”.

Next, users 220, such as ‘User X’, ‘User Y’ and ‘User Z’ receive communication regarding Service Request of user 220, such as “‘User A’ adding ‘Plumber’ as a skill/service needed. Next, users 220, such as ‘User X’, ‘User Y’ and ‘User Z’ display 208 updates with user 220, as ‘user A’ the Service Request information.

In block or step 1060.1 ‘User X’ display 208 additionally displays “User A Incoming Request: Plumber Busted pipe in my kitchen. Need help ASAP !! March 25 10:15 AM” Service Request of user 220, such as “‘User A’. In block or step 1060.2 ‘User Y’ display 208 additionally displays “User A Incoming Request: Plumber Busted pipe in my kitchen. Need help ASAP !! March 25 10:15 AM”, the Service Request of user 220, such as “‘User A’. In block or step 1060.3 ‘User Z’ display 208 additionally displays “User A Incoming Request: Plumber Busted pipe in my kitchen. Need help ASAP !! March 25 10:15 AM”, the Service Request of user 220, such as ‘User A’.

It is contemplated herein that users 220 may add any variety of skill/service or select preselected skill/service as a service requestor and communicate a new Service Request to users 220.

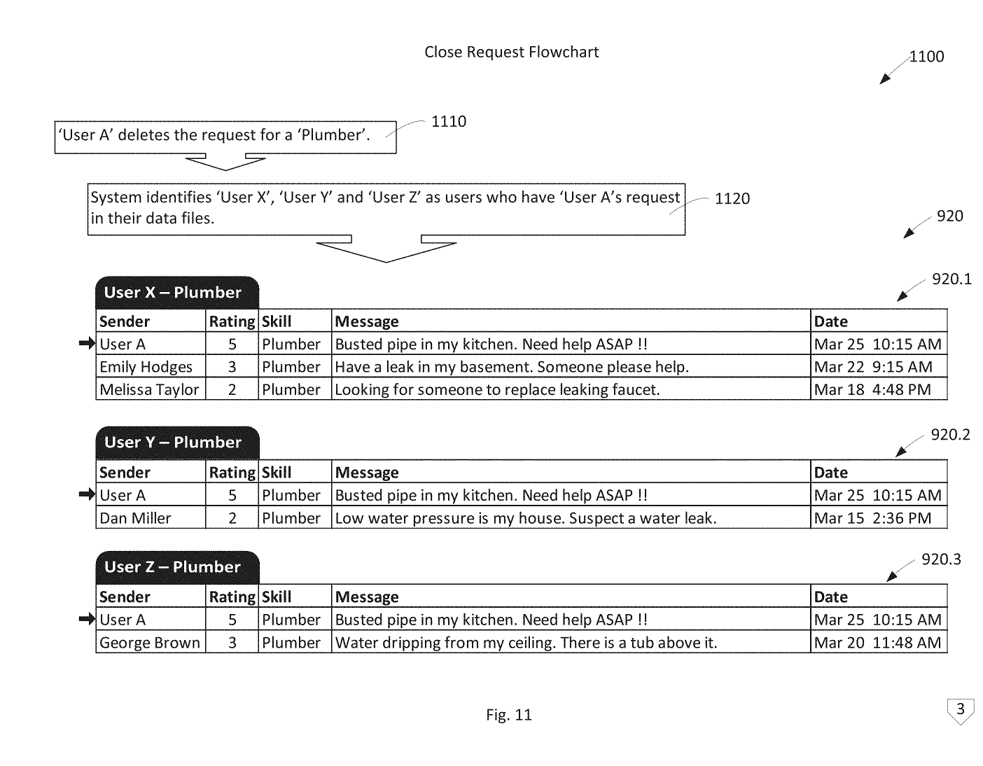

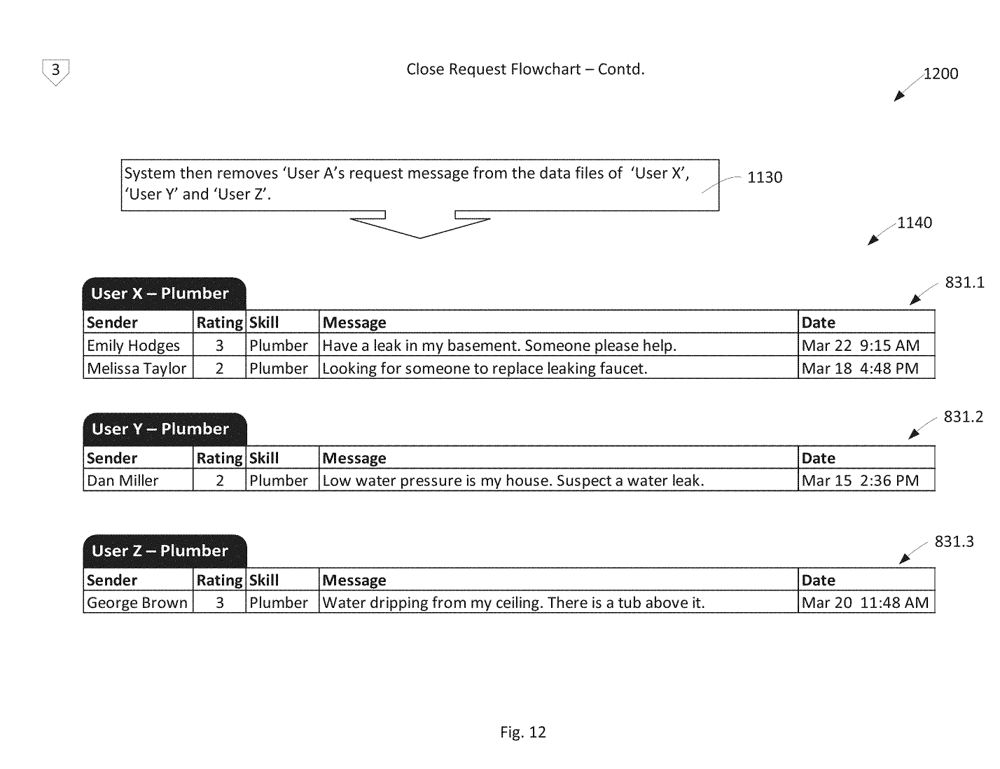

Referring now to FIGS. 11 and 12, by way of example, and not limitation, there is illustrated a block diagram and flow chart 1100 of an exemplary embodiment of user 220 closing a Service Request (Close Service request). In block or step 1110, user 220 may close a Service Request of user 220, such as “‘User A’ adding ‘Plumber’ as a Service Request, (Close Service Request). Web server 260 receives information from user 220 such as “‘User A’ and communicates same to Business Rules Engine (BRE) residing with database server 260, which acts on the user 220 input data to manipulate it and/or generate any output.

In block or step 1120, Business Rules Engine (BRE) residing with database server 260 searches and identifies all users 220 ‘User X’, ‘User Y’ and ‘User Z’ as users who have received ‘User A's Service Request of user 220 affiliated with ‘User A's Service Request, such as “‘User A’ adding ‘Plumber’ as a Service Request. Business Rules Engine (BRE) residing with database server 260 identifies three, such as, in block or step 920.1 user 220, such as ‘User X’ with listed skill or service of ‘Plumber’ having User Information UI, such as Sender 832 “User A’”, Rating 834, such as “5”, Skill 836, such as “Plumber”, Message 838, such as, “Busted pipe in my kitchen. Need help ASAP!!” and Date 839, such as “March 25 10:15 AM” as User Information UI.

In block or step 920.2, user 220, such as ‘User Y’ with listed skill or service of ‘Plumber’ having User Information UI, such as Sender 832 “User A’”, Rating 834, such as “5”, Skill 836, such as “Plumber”, Message 838, such as, “Busted pipe in my kitchen. Need help ASAP!!” and Date 839, such as “March 25 10:15 AM” as User Information UI.

In block or step 920.3, user 220, such as ‘User Z’ with listed skill or service of ‘Plumber’ having User Information UI, such as such as Sender 832 “User A’”, Rating 834, such as “5”, Skill 836, such as “Plumber”, Message 838, such as, “Busted pipe in my kitchen. Need help ASAP!!” and Date 839, such as “March 25 10:15 AM” as User Information UI.

In block or step 1130, Business Rules Engine (BRE) residing with database server 260 delete Service Request, such as user 220, ‘User A's Service Request of user 220, such as “‘User A’ adding ‘Plumber’ as a skill/service from each data file of users 220 ‘User X’, ‘User Y’ and ‘User Z’ (a delete service request data file) as users who have received ‘User A's Service Request. ‘User A's Service Request of user 220, such as “‘User A’ adding ‘Plumber’ as a skill/service. communicates an action to web server 260 (notification server 260) to delete or remove therefrom users 220 ‘User X’, ‘User Y’ and ‘User Z’ all communications therefrom user 220, as “‘User A’ relating to Service Request of user 220, such as “‘User A’ adding ‘Plumber’ as a Service Request to display 208 of users 220 ‘User X’, ‘User Y’ and ‘User Z.

It is contemplated herein that all communications relating to ‘User A's Service Request or communication threads related to ‘User A's Service Request will be deleted from current user 220 as well as from user 220 that request Service Request, including all the back and forth communication that has resulted from Service Request.

Again in block or step 1140, web server 260 may communicate Business Rules Engine (BRE) generated output communication to users 220 ‘User X’, ‘User Y’ and ‘User Z’ display 280—For example in block or step 1140, and more specifically in block or step 831.1 user 220, such as ‘User X’ with listed skill or service of ‘Plumber’ having User Information UI, such as Sender 832, such as “Emily Hodges” and “Melissa Taylor”, Rating 834, such as “3” and “2” respectively, Skill 836, such as “Plumber”, Message 838, such as, “Have a leak in my basement. Someone please help.” and “Looking for someone to replace leaking faucet.” and Date 839, such as “March 22 9:15 AM” and “March 18 4:48 PM”. In block or step 831.2, user 220, such as ‘User Y’ with listed skill or service of ‘Plumber’ having User Information UI, such as Sender 832, such as “Dan Miller”, Rating 834, such as “3”, Skill 836, such as “Plumber”, Message 838, such as, “Low water pressure is my house. Suspect a water leak.”, and Date 839, such “March 15 2:36 PM”. In block or step 831.3, user 220, such as ‘User Z’ with listed skill or service of ‘Plumber’ having User Information UI, such as Sender 832, such as “George Brown”, Rating 834, such as “3”, Skill 836, such as “Plumber”, Message 838, such as, “Water dripping from my ceiling. There is a tub above it.”, and Date 839, such “March 20 11:48 PM”.

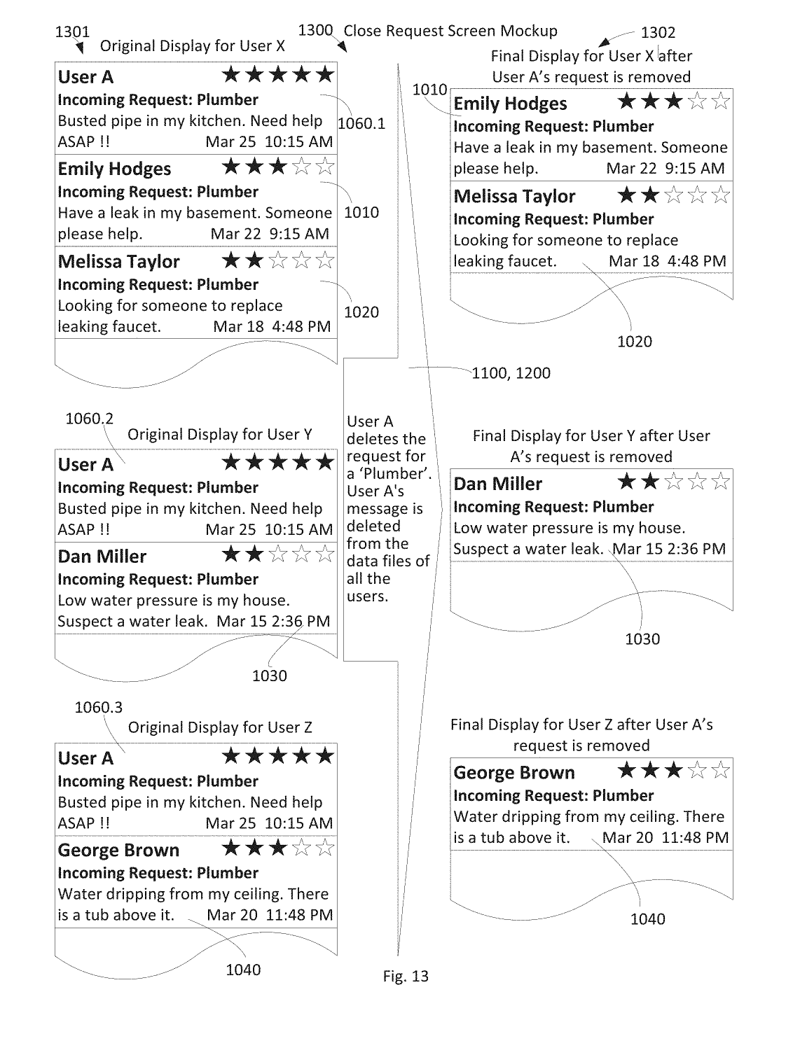

Referring now to FIG. 13, by way of example, and not limitation, there is illustrated users 220 ‘User X’, ‘User Y’ and ‘User Z’ display 208 displaying screen shots 1300, the steps set forth in FIGS. 11 and 12. Web server 260 displays communications between users 220 ‘User A’, ‘User X’, ‘User Y’ and ‘User Z’ deleting Service Request of user 220, such as “‘User A’ adding ‘Plumber’ as a Service Request displayed on display 208 of users 220 ‘User X’, ‘User Y’ and ‘User Z, shown as original Display 1301 and Final Display 1302.

Original Display 1301

In block or step 1060.1 ‘User X’ display 208 additionally displays “User A Incoming Request: Plumber Busted pipe in my kitchen. Need help ASAP !! March 25 10:15 AM”. In block or step 1010, user 220 as ‘User X’ display 208 displays “Emily Hodges Incoming Request: Plumber Have a leak in my basement. Someone please help. March 22 9:15 AM”. In block or step 1020, user 220 as ‘User X’ display 208 displays “Melissa Taylor Incoming Request: Plumber Looking for someone to replace leaking faucet. March 18 4:48 PM”.

In block or step 1060.2 ‘User Y’ display 208 additionally displays “User A Incoming Request: Plumber Busted pipe in my kitchen. Need help ASAP !! March 25 10:15 AM”. In block or step 1030, user 220 as ‘User Y’ display 208 displays “Dan Miller Incoming Request: Plumber Low water pressure is my house. Suspect a water leak. March 15 2:36 PM”.

In block or step 1060.3 ‘User Z’ display 208 additionally displays “User A Incoming Request: Plumber Busted pipe in my kitchen. Need help ASAP !! March 25 10:15 AM”, the Service Request of user 220, such as ‘User A’. In block or step 1040, user 220 as ‘User Z’ display 208 displays “George Brown Incoming Request: Plumber Water dripping from my ceiling. There is a tub above it. March 20 11:48 PM”.

Final Display 1302

Next, in block or step 1302, system and computer-implemented method 201 deletes Service Request of user 220, such as “‘User A’ deleting/closing ‘Plumber’ as a Service Request displayed on display 208 from users 220 ‘User X’, ‘User Y’ and ‘User Z.

In block or step 1010, user 220 as ‘User X’ display 208 displays “Emily Hodges Incoming Request: Plumber Have a leak in my basement. Someone please help. March 22 9:15 AM”. In block or step 1020, user 220 as ‘User X’ display 208 displays “Melissa Taylor Incoming Request: Plumber Looking for someone to replace leaking faucet. March 18 4:48 PM”.

In block or step 1030, user 220 as ‘User Y’ display 208 displays “Dan Miller Incoming Request: Plumber Low water pressure is my house. Suspect a water leak. March 15 2:36 PM”.

In block or step 1040, user 220 as ‘User Z’ display 208 displays “George Brown Incoming Request: Plumber Water dripping from my ceiling. There is a tub above it. March 20 11:48 PM”.

It is contemplated herein that computer-implemented method 201 for communicating with select group(s) of users 220 may delete prior notifications from users 220 display 208 via The Notification Service Layer (NSL) resides with notification server 260, which ensures timely outbound communication between the system and the User Interface used by the users 220. Currently, NSL consists of Apple Push Notification Service (APNS), Google Cloud Messaging (GCM), and Windows Push Notification, each service catering to its namesake Smartphone platform. The notifications received by NSL from the BRE are pushed to the appropriate recipient user device by the above mentioned services.

It is further contemplated herein that computer-implemented method 201 for communicating with select group(s) of users 220 may delete any and all prior communications or notifications, relating to a Service Request from user 220, as ‘User A’, from other users 220, such as ‘User X’, ‘User Y’ and ‘User Z’ without any permissions from ‘User X’, ‘User Y’ and ‘User Z’.

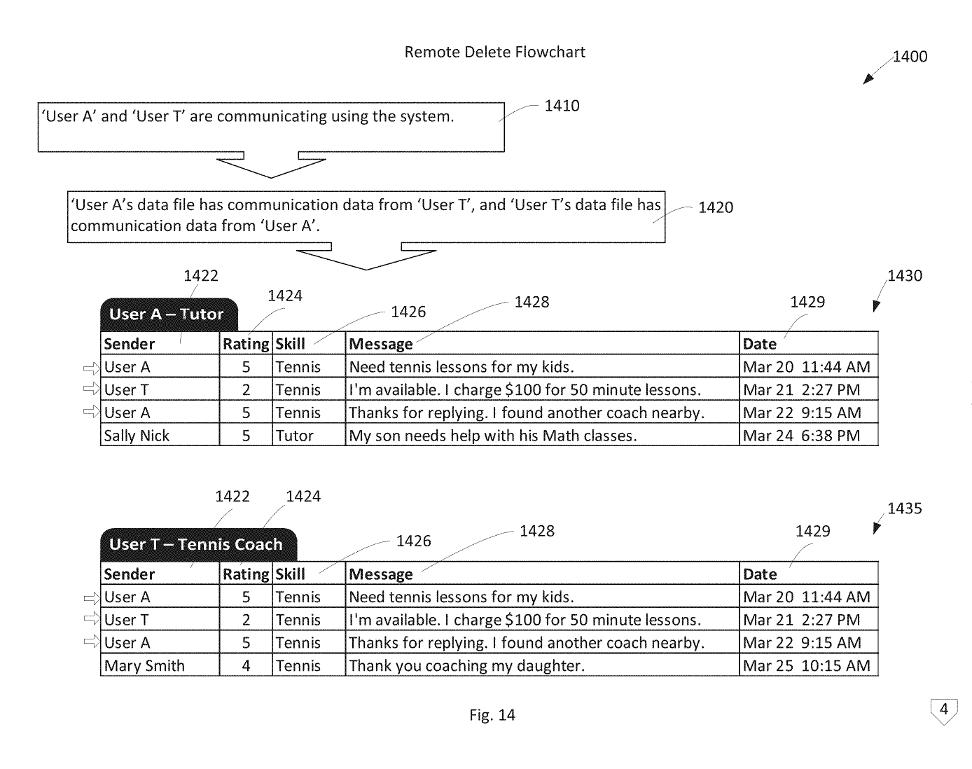

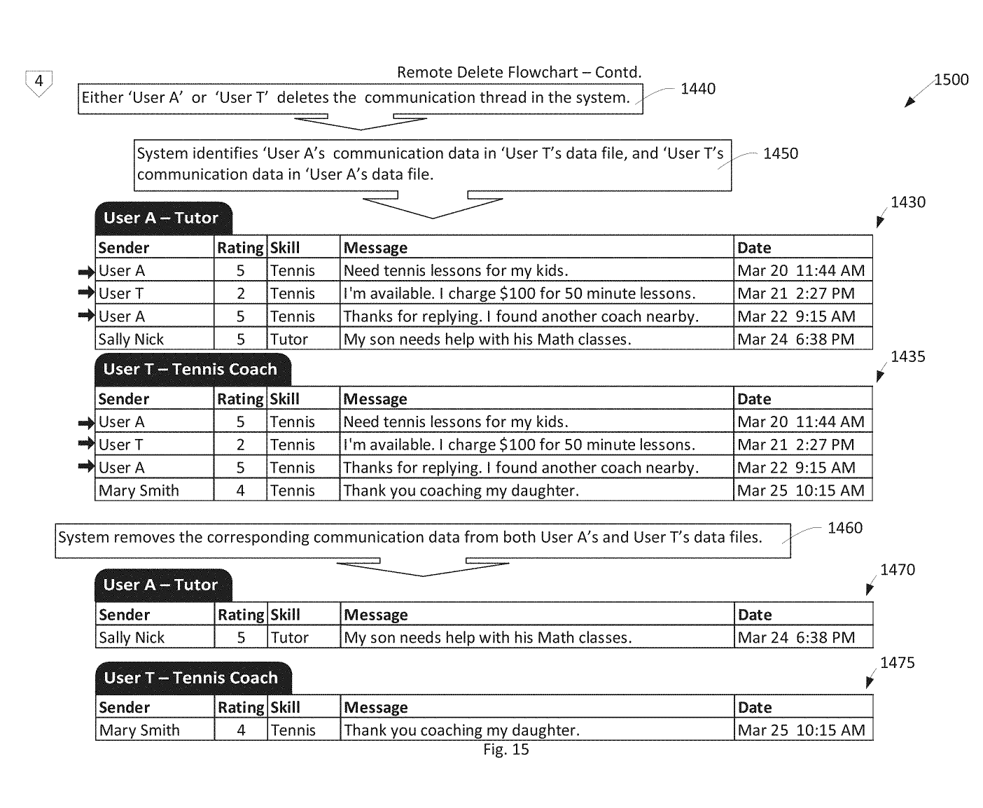

Referring now to FIGS. 14 and 15, by way of example, and not limitation, there is illustrated a block diagram and flow chart 1400 of an exemplary embodiment of user 220 deleting a Communication Thread or communication file therein computer-implemented method 201 for communicating with select group(s) of users 220. In block or step 1410, user 220 such as ‘User A’ may be communicating or messaging another user 220, such as ‘User T’. Web server 260 and/or notification server 260 receives information from user 220 such as ‘User A’ and communicates same message to user 220, such as ‘User T’ and vice-versa.

User A Communication Thread

In block or step 1430, user 220 such as ‘User A’—Tutor’ may be communicating or messaging or responding to another user 220, such as ‘User T’—Tennis Coach and user 220, such as ‘User T’ may be responding to user 220, such as ‘User A’ creating Communication Thread therebetween users 220 of computer-implemented method 201 for communicating with select group(s) of users 220. Business Rules Engine (BRE) residing with database server 260 stores communications between users 220. For example, user 220, such as ‘User A’ Communication Thread may have the following messages such as Sender 1422 “User A’”, Rating 1424, such as “5”, Skill 1426, such as “Tennis”, Message 1428, such as, “Need tennis lessons for my kids.” and Date 1429, such as “March 20 11:44 AM” as User Information UI; user 220, such as ‘User T’ Communication Thread may have the following response messages to user 220, such as ‘User A’, such as Sender 1422, such as “User T”, Rating 1424, such as “2”, Skill 1426, such as “Tennis”, Message 1428, such as, “I'm available. I charge $100 for 50 minute lessons.” and Date 1429, such as “March 21 2:27 PM”; and user 220, such as ‘User A’ Communication Thread may have the following response messages to user 220, such as ‘User T’, such as Sender 1422 “User A’”, Rating 1424, such as “5”, Skill 1426, such as “Tennis”, Message 1428, such as, “Thanks for replying. I found another coach nearby.” and Date 1429, such as “March 20 11:44 AM” as User Information UI. It is contemplated herein that other communications between user 220 such as ‘User A’ and other users 220 may be enabled by computer-implemented method 201 for communicating with select group(s) of users 220, such as user 220, such as ‘User A’, such as Sender 1422 “Sally Nick”, Rating 1424, such as “5”, Skill 1426, such as “Tutor”, Message 1428, such as, “My son needs help with his Math classes.” and Date 1429, such as “March 24 6:38 PM” as User Information UI.

User T Communication Thread

In block or step 1435, user 220 such as ‘User T’—Tennis Coach may be communicating or messaging or responding to another user 220, such as ‘User A’—Tutor and user 220, such as ‘User A’ may be responding to user 220, such as ‘User T’ creating Communication Thread therebetween users 220 of computer-implemented method 201 for communicating with select group(s) of users 220. Business Rules Engine (BRE) residing with database server 260 stores communications between users 220. For example, user 220, such as ‘User A’ Communication Thread may have the following messages such as Sender 1422 “User A’”, Rating 1424, such as “5”, Skill 1426, such as “Tennis”, Message 1428, such as, “Need tennis lessons for my kids.” and Date 1429, such as “March 20 11:44 AM” as User Information UI; user 220, such as ‘User T’ Communication Thread may have the following response messages to user 220, such as ‘User A’, such as Sender 1422, such as “User T”, Rating 1424, such as “2”, Skill 1426, such as “Tennis”, Message 1428, such as, “I'm available. I charge $100 for 50 minute lessons.” and Date 1429, such as “March 21 2:27 PM”; and user 220, such as ‘User A’ Communication Thread may have the following response messages to user 220, such as ‘User T’, such as Sender 1422 “User A’”, Rating 1424, such as “5”, Skill 1426, such as “Tennis”, Message 1428, such as, “Thanks for replying. I found another coach nearby.” and Date 1429, such as “March 20 11:44 AM” as User Information UI. It is contemplated herein that other communications between user 220 such as ‘User T’ and other users 220 may be enabled by computer-implemented method 201 for communicating with select group(s) of users 220, such as user 220, such as ‘User T’, such as Sender 1422 “Mary Smith”, Rating 1424, such as “4”, Skill 1426, such as “Tennis”, Message 1428, such as, “Thank you coaching my daughter.” and Date 1429, such as “March 25 10:15 PM” as User Information UI.

In block or step 1440, either users 220, whether ‘User A’ or ‘User T’ decides to delete Communication Thread or communication file therebetween users 220, ‘User A’ and ‘User T’ of computer-implemented method 201 for communicating with select group(s) of users 220. User 220 communicates such action to delete communication file between user 220 such as ‘User A’ and user 220, such as ‘User T’ to web server 260 (notification server 260), which communicates such action to Business Rules Engine (BRE) residing with database server 260, which acts on the user 220 input data to manipulate it and/or generate any output.

In block or step 1450, Business Rules Engine (BRE) residing with database server 260 identifies user 220, such as ‘User A's communication data with user 220, such as ‘User T's data file, and user 220, such as ‘User T's communication data with user 220, such as ‘User A's data file affiliated to both users 220 such as:

‘User A’ and ‘User T’ Communication Thread

Sender 1422 “User A’”, Rating 1424, such as “5”, Skill 1426, such as “Tennis”, Message 1428, such as, “Need tennis lessons for my kids.” and Date 1429, such as “March 20 11:44 AM” as User Information UI; user 220, such as ‘User T’ Communication Thread may have the following response messages to user 220, such as ‘User A’, such as Sender 1422, such as “User T”, Rating 1424, such as “2”, Skill 1426, such as “Tennis”, Message 1428, such as, “I'm available. I charge $100 for 50 minute lessons.” and Date 1429, such as “March 21 2:27 PM”; and user 220, such as ‘User A’ Communication Thread may have the following response messages to user 220, such as ‘User T’, such as Sender 1422 “User A’”, Rating 1424, such as “5”, Skill 1426, such as “Tennis”, Message 1428, such as, “Thanks for replying. I found another coach nearby.” and Date 1429, such as “March 20 11:44 AM” as User Information UI.

In block or step 1460, Business Rules Engine (BRE) residing with database server 260 deletes user 220, such as ‘User A's communication data, Communication Thread, with user 220, such as ‘User T's data file, and user 220, such as ‘User T's reciprocal communication data (affiliated), Communication Thread, with user 220, such as ‘User A's, a delete communication data file. Business Rules Engine (BRE) residing with database server 260 instructs web server 260 (notification server 260) to delete or remove or remotely delete therefrom users 220, more specifically users 220, such as ‘User A’ and user 220, such as ‘User T’ communication data therebetween, such as Communication Thread, a delete communication data file.

Moreover, Business Rules Engine (BRE) residing with database server 260 communicates an action to web server 260 (notification server 260) to communicate update communication file to users 220, such as ‘User A’ and users 220, such as ‘User T’ or delete or remove therefrom users 220, users 220, such as ‘User A’ and users 220, such as ‘User T’ all communications therefrom user 220, as “‘User A’ relating to Communication Thread of user 220, such as “‘User A’ and user 220, such as “‘User T’ communication relating to Communication Thread and identified in block or step 1430 and 1435.

For example:

User A—Tutor Communication Thread Thereafter

In block or step 1470, user 220, such as ‘User A’, such as Sender 1422 “Sally Nick”, Rating 1424, such as “5”, Skill 1426, such as “Tutor”, Message 1428, such as, “My son needs help with his Math classes.” and Date 1429, such as “March 24 6:38 PM” as User Information UI.

User T—Tennis Coach Communication Thread Thereafter

In block or step 1475, user 220, such as ‘User T’, such as Sender 1422 “Mary Smith”, Rating 1424, such as “4”, Skill 1426, such as “Tennis”, Message 1428, such as, “Thank you coaching my daughter.” and Date 1429, such as “March 25 10:15 PM” as User Information.

It is contemplated herein that one or more service providers or one or more service requestors may delete any communication file or communication thread between any user 220 without permission or consent of the other users 220.

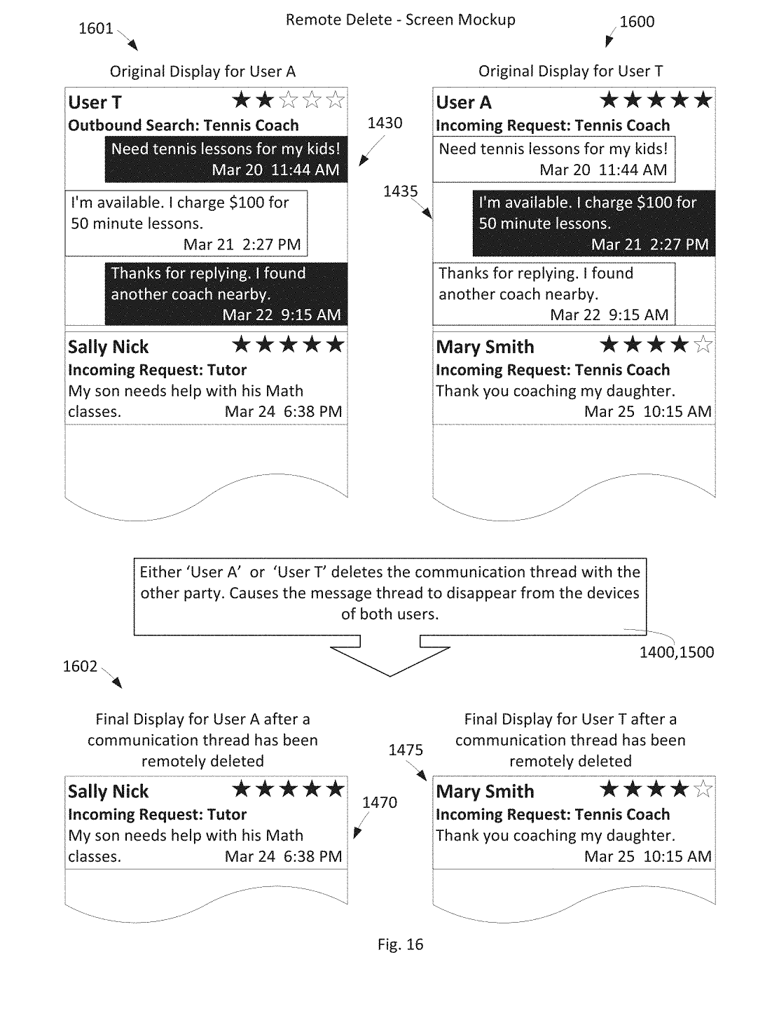

Referring now to FIG. 16, by way of example, and not limitation, there is illustrated users 220 ‘User A’ and ‘User T’, display 208 displaying screen shots 1600, the steps set forth in FIGS. 14 and 15. Web server 260 displays communications between users 220 ‘User A’ and ‘User T’ deleting Communication Thread of user 220, such as “‘User A’ inquiry regarding ‘tennis lessons’ as a Service Request displayed on display 208 of users 220 ‘User A’ and ‘User T’, shown as original Display 1601 and Final Display 1602.

Original Display 1601

In block or step 1430 ‘User A’ display 208 originally displays message from “User T Outbound Search: Tennis Coach Need tennis lessons for my kids! March 20 11:44 AM”; “I'm available. I charge $100 for 50 minute lessons March 21 2:27 PM”; “Thanks for replying. I found another coach nearby. March 22 9:15 AM”; “Sally Nick Incoming Request: Tutor My son needs help with his Math classes. March 24 6:38 PM”.

In block or step 1435 ‘User T’ display 208 originally displays message from “User A Incoming Request: Tennis Coach Need tennis lessons for my kids! March 20 11:44 AM”; “Thanks for replying. I found another coach nearby. March 22 9:15 AM”; “Mary Smith Incoming Request: Tennis Coach Thank you coaching my daughter. March 25 10:15 AM”

In block or step 1460, Business Rules Engine (BRE) residing with database server 260 deletes user 220, such as ‘User A's communication data, Communication Thread, with user 220, such as ‘User T's data file, and user 220, such as ‘User T's reciprocal communication data, Communication Thread, with user 220, such as ‘User A's. Business Rules Engine (BRE) residing with database server 260 instructs web server 260 (notification server 260) to delete or remove or remotely delete therefrom users 220, more specifically users 220, such as ‘User A’ and user 220, such as ‘User T’ communication data therebetween, such as Communication Thread.

Moreover, Business Rules Engine (BRE) residing with database server 260 communicates an action to web server 260 (notification server 260) to delete or remove therefrom users 220, users 220, such as ‘User A’ and users 220, such as ‘User T’ all communications therefrom user 220, as ‘User A’ relating to Communication Thread of user 220, such as “‘User A’ and user 220, such as “‘User T’ communication relating to Communication Thread and identified in block or step 1430 and 1435.

Final Display 1602

For example:

User A—Tutor Communication Thread Thereafter

In block or step 1470 ‘User A’ display 208, after a communication thread has been remotely deleted, finally displays “Sally Nick Incoming Request: Tutor My son needs help with his Math classes. March 24 6:38 PM”

User T—Tennis Coach Communication Thread Thereafter In block or step 1475 ‘User T’ display 208, after a communication thread has been remotely deleted, finally displays “Mary Smith Incoming Request: Tennis Coach Thank you coaching my daughter. March 25 10:15 AM”

It is contemplated herein that either user 220, such as ‘User A’ or ‘User T’ may delete the Communication Thread without the consent or permission of the other party. System and computer-implemented method 201 for communicating with select group(s) of users 220 causes the Communication thread to disappear from the devices of both users, either user 220, such as ‘User A’ or ‘User T’.

It is further contemplated herein that computer-implemented method 201 for communicating with select group(s) of users 220 may delete any prior communications or notifications, relating to a Communication Thread between users 220, such as ‘User A’ and ‘User T’ without any permissions from the other user ‘User T’ and ‘User A’ respectively.

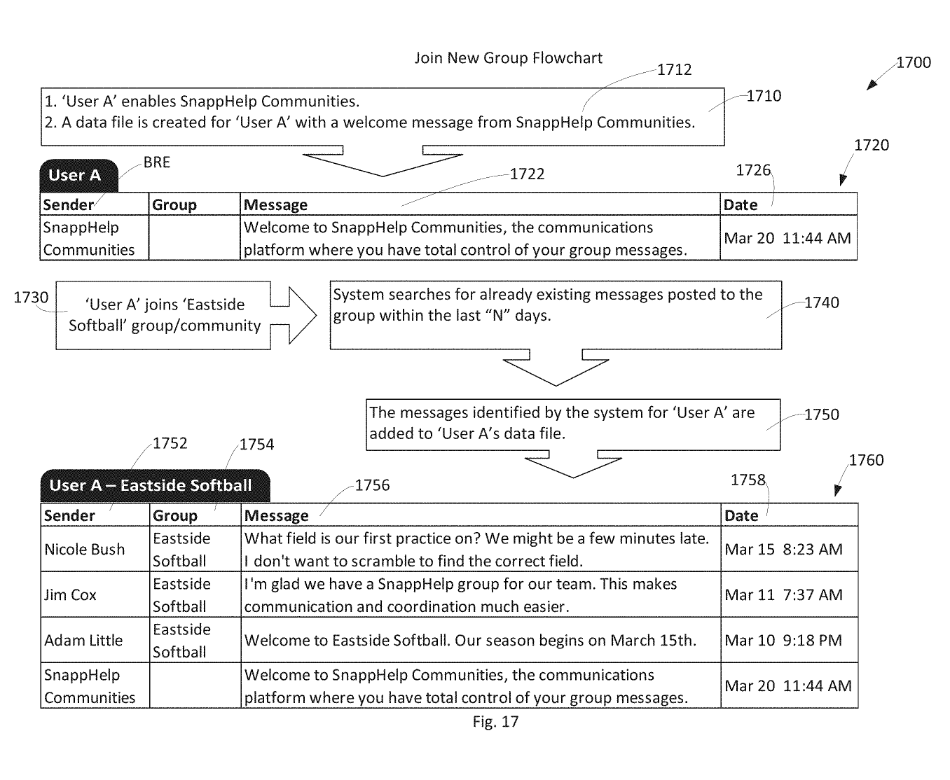

Referring now to FIG. 17, by way of example, and not limitation, there is illustrated a block diagram and flow chart 1700 of an exemplary embodiment of user 220 joining a new group (Group) via system and computer-implemented method 201 for communicating with select group(s) of users 220. In block or step 1710, Business Rules Engine (BRE) enables communities or group chat messaging within system and computer-implemented method 201 for communicating with select group(s) of users 220. Web server 260 receives user information UI, such as a request to join a new group (Group) from user 220 and communicates same to Business Rules Engine (BRE) residing with database server 260, which acts on the user 220 input data to manipulate it and/or generate any output, such as creating a data file 1712 of user 220 joining a new group and for user 220 to receive group communications.

In block or step 1720, web server 260 may communicate Business Rules Engine (BRE) generated output communication user 220 electing to join a group—Welcome message from SnappHelp Communities 1712 to user 220, such as “Welcome to SnappHelp Communities, the communications platform where you have total control of your group messages.” 1722 at date time 1726, such as “March 20 11:44 AM”.

Next, in block or step 1730, user 220, as ‘User A’ may join a group or community, such as ‘User A’ adds “User A’ joins ‘Eastside Softball’ group/community’ as join a new group (Group). Web server 260 receives information from user 220 and communicates same to Business Rules Engine (BRE) residing with database server 260, which acts on the user 220 input data to manipulate it and/or generate any output—supplying a list of groups or enables searching of existing groups or creation of a new group.

In block or step 1740, Business Rules Engine (BRE) residing with database server 260 searches database 270 for ‘Eastside Softball’ group/community’ (Group) having group communications data file of communications between users 220 (group communications) and identifies group with pre-existing messages posted to the Group within the last “N” days, such as “Eastside Softball group/community” as Group”.

In block or step 1750, Business Rules Engine (BRE) residing with database server 260 communicates group communications (existing messages posted to the Group within the last “N” days, such as “Eastside Softball group/community” as Group”) to Web server 260 and Web server 260 communicates group communications (existing messages posted to the Group within the last “N” days, such as “Eastside Softball group/community” as Group”) to user 220, such as ‘User A’.

In block or step 1760, user 220, such as ‘User A’ receives one or more group communications, such as text messages—three shown (existing messages posted to the Group within the last “N” days, such as “Eastside Softball group/community” as Group”), such communications may include user information UI, including Sender 1752, Group 1754, Message 1756, and Date 1758. For example, Sender 352, such as “Nicole Bush”, Group 1754, such as “Eastside Softball”, Message 1756, such as, “What field is our first practice on? We might be a few minutes late. I don't want to scramble to find the correct field.” and Date 1758, such as “March 8:23 AM.” Again, Sender 1752, such as “Jim Cox”, Group 1754, such as “Eastside Softball”, Message 1756, such as, Message 1756, such as, “I'm glad we have a SnappHelp group for our team. This makes communication and coordination much easier.” and Date 1758, such as “March 11 7:37 AM.” Again, Sender 1752, such as “Adam Little”, Group 1754, such as “Eastside Softball”, Message 1756, such as, Message 1756, such as, “Welcome to Eastside Softball. Our season begins on March 15th.” and Date 1758, such as “March 10 11:44 AM.”

It is contemplated herein that user 220, such as ‘User A’ requesting to join a group (Group) is immediately presented with users 220 communications previously presented to the Group and going forward new users 220, such as ‘User A’ and existing users 220 may communicate there with one another in the group (Group).

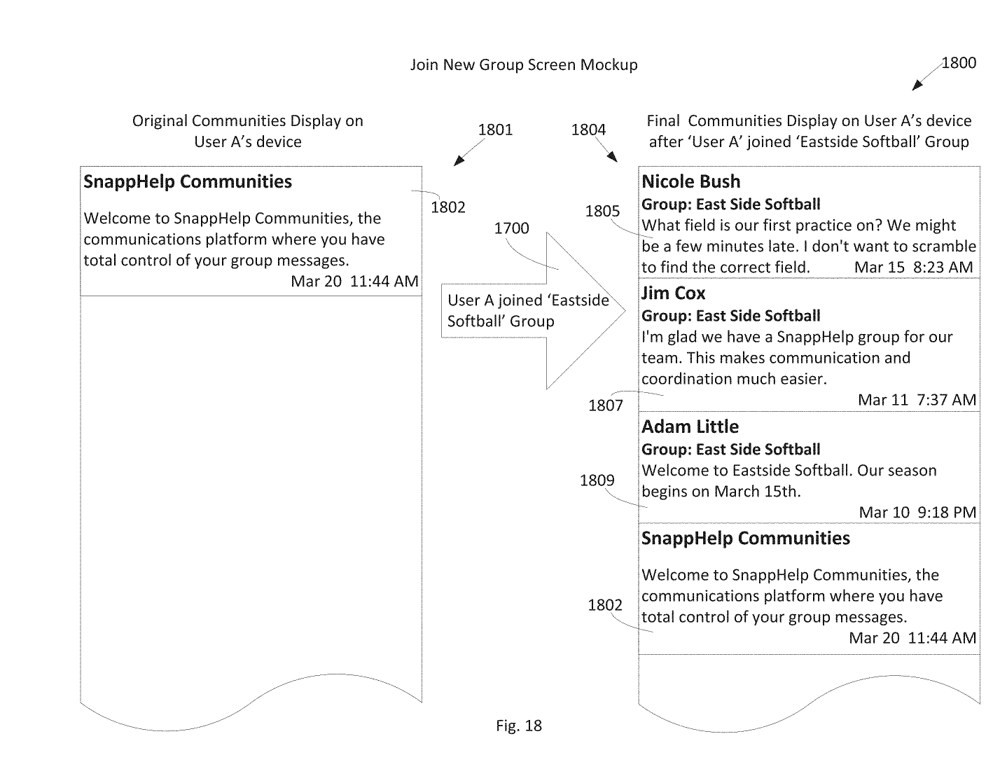

Referring now to FIG. 18, by way of example, and not limitation, there is illustrated user 220 display 208 displaying screen shots 1800, the steps set forth in FIG. 17. Web server 260 communicates group messages (user 220, such as ‘User A’ requesting to join a group (Group)) users 220, such as “‘User A’ as Original Communities Display on User A's device 1801 and “Final Communities Display on User A's device after ‘User A’ joined ‘Eastside Softball’ Group” Final Display 1804.

Original Communities Display

In block or step 1802, user 220 display 208 displays “SnappHelp Communities Welcome to SnappHelp Communities, the communications platform where you have total control of your group messages. March 20 11:44 AM”.

Final Communities Display

Next, users 220, such as ‘User A’, receives communications of past communication within group (Group) such as ‘User A’ ‘Eastside Softball’ Group. Next, users 220, such as ‘User A’ display 208 updates with user 220, as ‘user A’ joined or linked with group (Group) such as ‘User A’ ‘Eastside Softball’ Group. Next, in block or step 1805-1809, user 220 receives previous communications between users of ‘Eastside Softball’ Group, such as in block or step 1805 “Nicole Bush Group: East Side Softball What field is our first practice on? We might be a few minutes late. I don't want to scramble to find the correct field. March 15 8:23 AM”; in block or step 1807 “Jim Cox Group: East Side Softball I'm glad we have a SnappHelp group for our team. This makes communication and coordination much easier. March 11 7:37 AM”; in block or step 1809 “Adam Little Group: East Side Softball Welcome to Eastside Softball. Our season begins on March 15th. March 10 9:18 PM”

It is contemplated herein that users 220 may joining a Group, communicate with other users in a Group, review past communications between users 220 of a Group, create a new Group via system and computer-implemented method 201 for communicating with select group(s) of users 220.

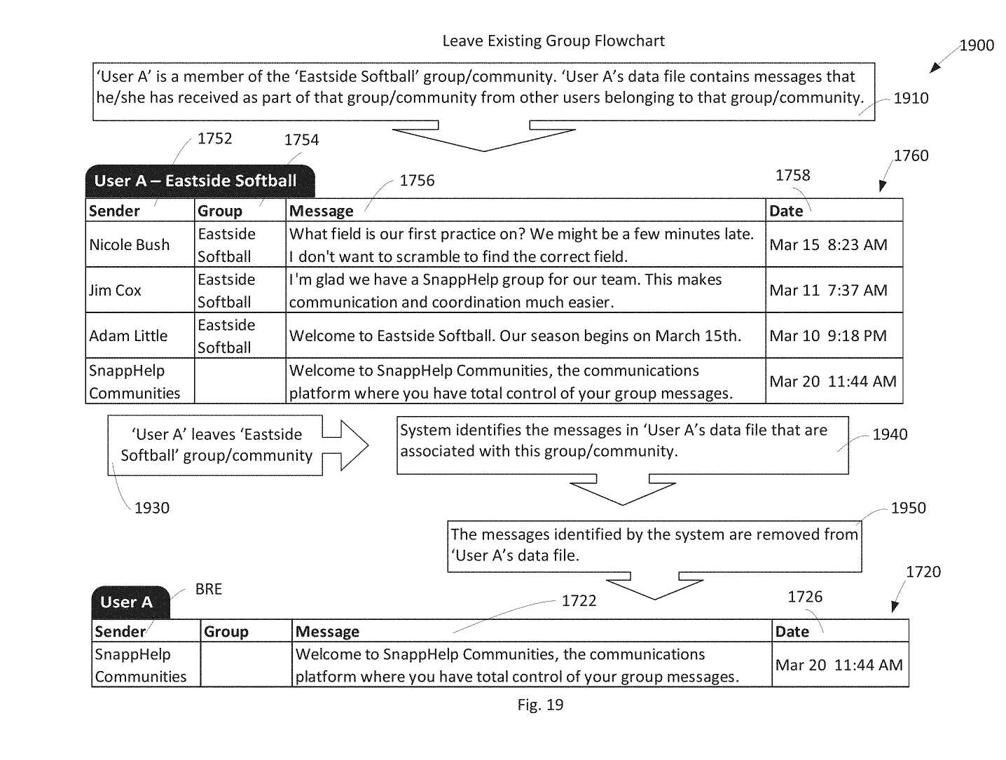

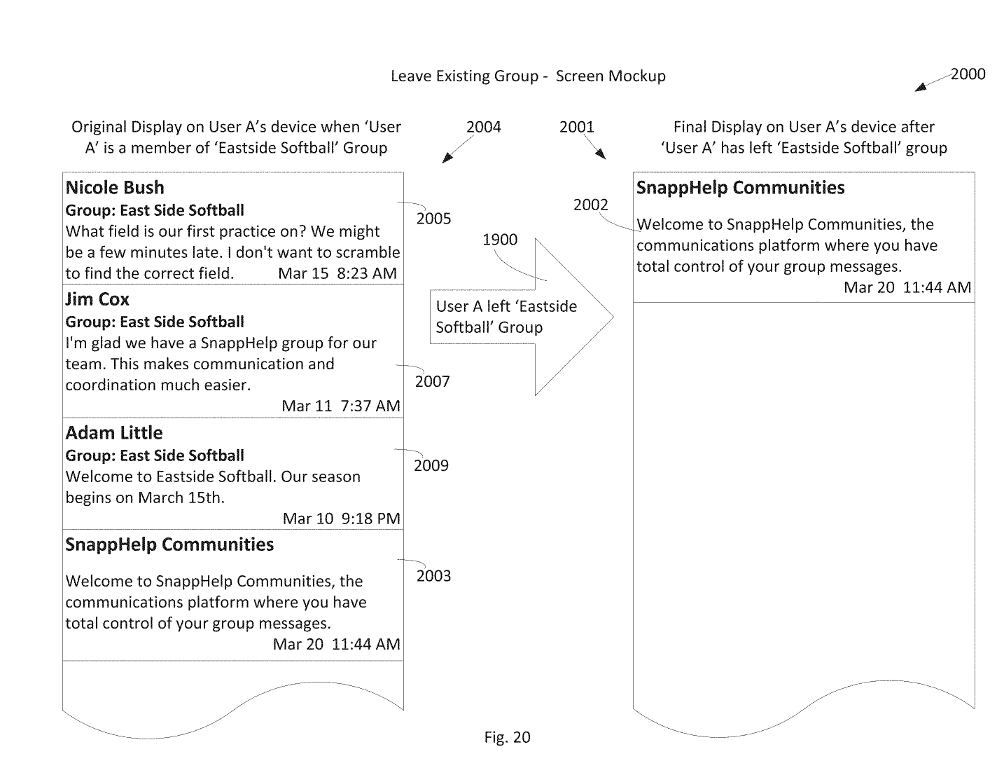

Referring now to FIGS. 19 and 20, by way of example, and not limitation, there is illustrated a block diagram and flow chart 1900 of an exemplary embodiment of user 220 leaving an existing group (Leave a Group) via system and computer-implemented method 201 for communicating with select group(s) of users 220. In block or step 1910, user 220, such as user A, a member of the ‘Eastside Softball’ group/community (Group). As a member of the ‘Eastside Softball’ group/community (Group) ‘User A's data file preferably contains messages that he/she has received as part of that group/community from other users 220 belonging to ‘Eastside Softball’ group/community (Group), such as such as text messages—three shown (existing messages posted to the Group within the last “N” days, such as “Eastside Softball group/community” as Group”), such communications may include user Information UI, including Sender 1752, Group 1754, Message 1756, and Date 1758. For example, Sender 1752, such as “Nicole Bush”, Group 1754, such as “Eastside Softball”, Message 1756, such as, “What field is our first practice on? We might be a few minutes late. I don't want to scramble to find the correct field.” and Date 1758, such as “March 15 8:23 AM.” Again, Sender 1752, such as “Jim Cox”, Group 1754, such as “Eastside Softball”, Message 1756, such as, Message 1756, such as, “I'm glad we have a SnappHelp group for our team. This makes communication and coordination much easier.” and Date 1758, such as “March 11 7:37 AM.” Again, Sender 1752, such as “Adam Little”, Group 1754, such as “Eastside Softball”, Message 1756, such as, “Welcome to Eastside Softball. Our season begins on March 15th.” and Date 1758, such as “March 10 11:44 AM.”; and Sender 1752, such as “SnappHelp Communities”, Message 1756, such as, “Welcome to SnappHelp, the communications platform designed to connect you with experts and to market your skills”, and Date 1758, such as “March 20 11:44 AM”.

Next, in block or step 1930, user 220, as ‘User A’ may decide to leave a group or community, such as ‘User A’ leaves ‘Eastside Softball’ group/community’ (Group). Web server 260 receives information from user 220 (decision to leave a group) and communicates same to Business Rules Engine (BRE) residing with database server 260, which acts on the user 220 input data to manipulate it and/or generate any output.

In block or step 1940, Business Rules Engine (BRE) residing with database server 260 searches database 270 and identifies all user 220 communications relating to user 220, as ‘User A’, user data file and group ‘Eastside Softball’ group/community’ (Group) group data file—identifying messages in ‘User A's data file associated with this group/community—‘Eastside Softball’ group/community’ (Group) group data file.

Business Rules Engine (BRE) residing with database server 260 identifies three, such as Senders 1752, including “Nicole Bush”, Group 1754, such as “Eastside Softball”, Message 1756, such as, “What field is our first practice on? We might be a few minutes late. I don't want to scramble to find the correct field.” and Date 1758, such as “March 15 8:23 AM.” Again, Sender 1752, such as “Jim Cox”, Group 1754, such as “Eastside Softball”, Message 1756, such as, “I'm glad we have a SnappHelp group for our team. This makes communication and coordination much easier.” and Date 1758, such as “March 11 7:37 AM.” Again, Sender 1752, such as “Adam Little”, Group 1754, such as “Eastside Softball”, Message 1756, such as, “Welcome to Eastside Softball. Our season begins on March 15th.” and Date 1758, such as “March 10 11:44 AM.”;

In block or step 1950, Business Rules Engine (BRE) residing with database server 260 deletes user 220, as ‘User A’, user data file from group ‘Eastside Softball’ group/community’ (Group) group data file or communicates an action to web server 260 (notification server 260) to delete or remove therefrom user 220 all communications therefrom user 220, as “‘User A’ user data file relating to group/community—‘Eastside Softball’ group/community’ (Group)) and from other users 220 system and computer-implemented method 201 for communicating with select group(s) of users 220, group data file, a delete communication data file.

It is contemplated herein that all communications relating to ‘User A's group/community—‘Eastside Softball’ group/community’ (Group) or communication threads related to ‘User A's group/community—‘Eastside Softball’ group/community’ (Group) will be deleted from current user 220 as well as from user 220 that request to join group/community—‘Eastside Softball’ group/community’ (Group), including all the back and forth communication that has resulted from ‘User A's group/community—‘Eastside Softball’ group/community’ (Group).

Again in block or step 1950, web server 260 may communicate Business Rules Engine (BRE) generated output communication, a delete communication data file to user 220, as User A on display 208—Message 1722, such as, “Welcome to SnappHelp Communities, the communications platform where you have total control of your group messages.”, date time 1726, such as “March 20 11:44 AM” to user 220 as ‘User A’.

Referring now to FIG. 20, by way of example, and not limitation, there is illustrated user 220 display 208 displaying screen shots 2000, the steps set forth in FIG. 19. Web server 260 displays communications between users 220 leaving an existing group (Leave Group) by user 220, such as “‘User A’, shown as Original Display 2004 and Final Display 2001.

Original Display 2004

In block or step 2005-2009, user 220 original display of users 220 requesting to leaving an existing group, such as relating to group/community—‘Eastside Softball’ group/community’ (Group) and user 220 display 208 displayed in block or step 2005 “Nicole Bush Group: East Side Softball What field is our first practice on? We might be a few minutes late. I don't want to scramble to find the correct field. March 15 8:23 AM”; in block or step 2007 “Jim Cox Group: East Side Softball I'm glad we have a SnappHelp group for our team. This makes communication and coordination much easier. March 11 7:37 AM”; in block or step 2009 “Adam Little Group: East Side Softball Welcome to Eastside Softball. Our season begins on March 15th. March 10 9:18 PM”; and in block or step 2003 “SnappHelp Communities Welcome to SnappHelp Communities, the communications platform where you have total control of your group messages. March 20 11:44 AM”

Final Display 2001

Next, in block or step 2002, system and computer-implemented method 201 deletes communications (data file) related to user 220, as “‘User A’ and requesting to leaving an existing group, such as relating to group/community—‘Eastside Softball’ group/community’ (Group) from display 208 where all user 220 display 208 displays “SnappHelp Communities Welcome to SnappHelp Communities, the communications platform where you have total control of your group messages. March 20 11:44 AM”.

It is contemplated herein that computer-implemented method 201 for communicating with select group(s) of users 220 may delete prior message and group communications from users 220 display 208 without prior consent or permission from other users 220.

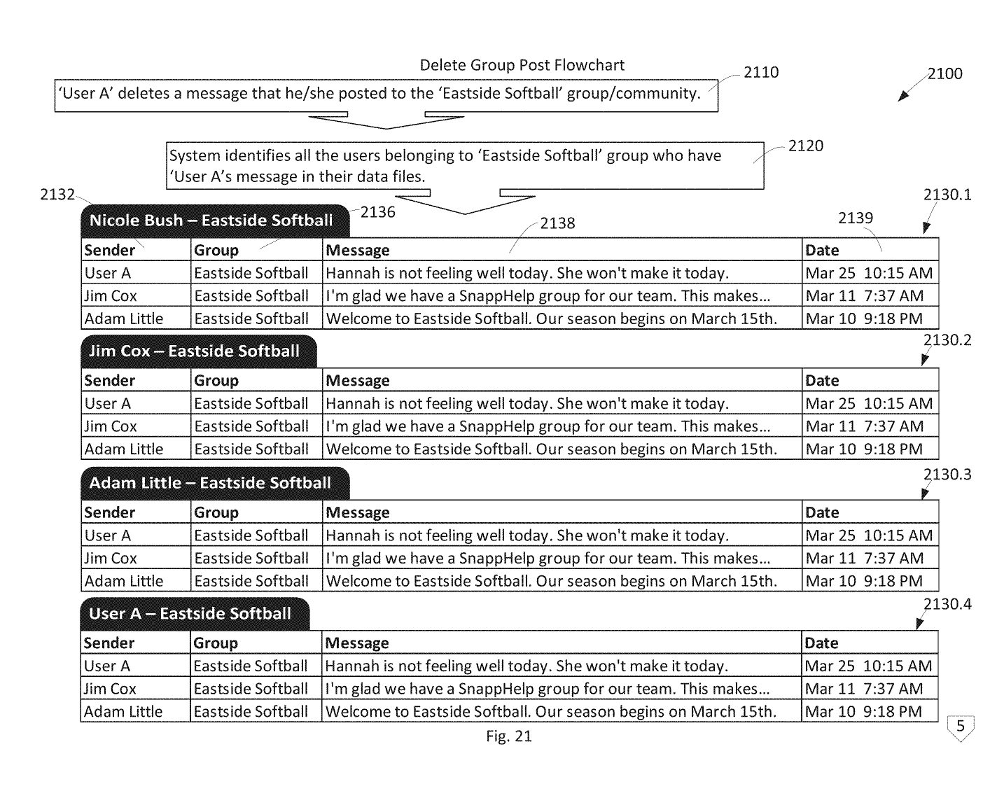

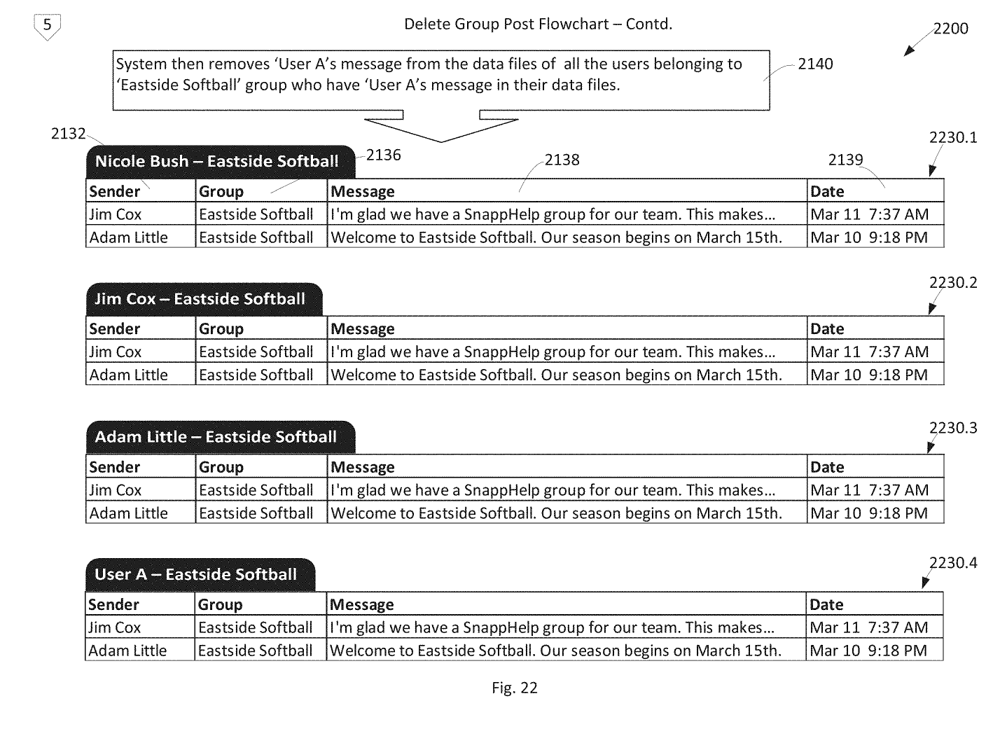

Referring now to FIGS. 21 and 22, by way of example, and not limitation, there is illustrated a block diagram and flow chart 2100 of an exemplary embodiment of user 220 deleting a user 220 message to a group/community, such as ‘Eastside Softball’ group/community’ (Group Message). In block or step 2110, user 220 may delete user 220 communication or message—user data file posted to a group/community, such as ‘Eastside Softball’ group/community’—group communication data file. Web server 260 receives information from user 220 such as “‘User A’ to delete user A communication from and communicates same to Business Rules Engine (BRE) residing with database server 260, which acts on the user 220 input data to manipulate it and/or generate any output.

In block or step 2120, Business Rules Engine (BRE) residing with database server 260 searches group/community, such as ‘Eastside Softball’ group/community’—group communication data file and identifies all users 220 who have received ‘User A's messages—user's data file affiliated or regarding message to a group/community, such as ‘Eastside Softball’ group/community’ (Group) stored in user's group communications data file. Business Rules Engine (BRE) residing with database server 260 identifies three, user communications between user 220, such as “‘User A’ and users 220, such as ‘Nicole Bush’ 2130.1, user 220, such as ‘Jim Cox’ 2130.2, user 220, such as ‘Adam Little’ 2130.3, user 220, such as ‘User A’ 2130.4, and which are members of group/community, such as ‘Eastside Softball’ group/community’ (Group) having data files of User Information UI, such as sender 2132 “User A’”, Group 2136, such as “Eastside Softball”, Message 2138, such as, “Hannah is not feeling well March 25 10:15 AM” as User Information UI; such as sender 2132 “Jim Cox”, Group 2136, such as “Eastside Softball”, Message 2138, such as, “I'm glad we have a SnappHelp group for our team. This makes . . . ”, Date 2139, such as March 11 7:37 AM″ as User Information UI; and sender 2132 “Adam Little”, Group 2136, such as “Eastside Softball”, Message 2138, such as, “Welcome to Eastside Softball. Our season begins on March 15th.” Date 2139, such as March 10 9:18 AM″ as User Information UI″.

In block or step 2140, Business Rules Engine (BRE) residing with database server 260 communicates a delete group communication data file—group/community, such as ‘Eastside Softball’ group/community’—group communication data file without users 220 ‘User A's messages—user data file to web server 260 (notification server 260) or communicates to web server 260 (notification server 260) to delete or remove user 220, such as “‘User A’ message from group communication data files of users 220 associated with group/community, such as ‘Eastside Softball’ group/community’ (Group), such as user 220, such as ‘Nicole Bush’ 2130.1, user 220, such as ‘Jim Cox’ 2130.2, and user 220, such as ‘Adam Little’ 2130.3.

Again in block or step 2140, web server 260 may communicate Business Rules Engine (BRE) generated output communication to user 220, such as ‘Nicole Bush’ 2130.1, user 220, such as ‘Jim Cox’ 2130.2, and user 220, such as ‘Adam Little’ 2130.3 displays 208—For example, having data files of User Information UI, such as in block or step 2230, user 220, such as ‘Nicole Bush’ 2230.1, user 220, such as ‘Jim Cox’ 2230.2, user 220, such as ‘Adam Little’ 2230.3 having messages from members of group/community, such as ‘Eastside Softball’ group/community’ (Group) having data files of User Information UI, such as sender 2132 “Jim Cox”, Group 2136, such as “Eastside Softball”, Message 2138, such as, “I'm glad we have a SnappHelp group for our team. This makes . . . ”, Date 2139, such as March 11 7:37 AM″ as User Information UI; and sender 2132 “Adam Little”, Group 2136, such as “Eastside Softball”, Message 2138, such as, “Welcome to Eastside Softball. Our season begins on March 15th.” Date 2139, such as March 10 9:18 AM″ as User Information UI″.

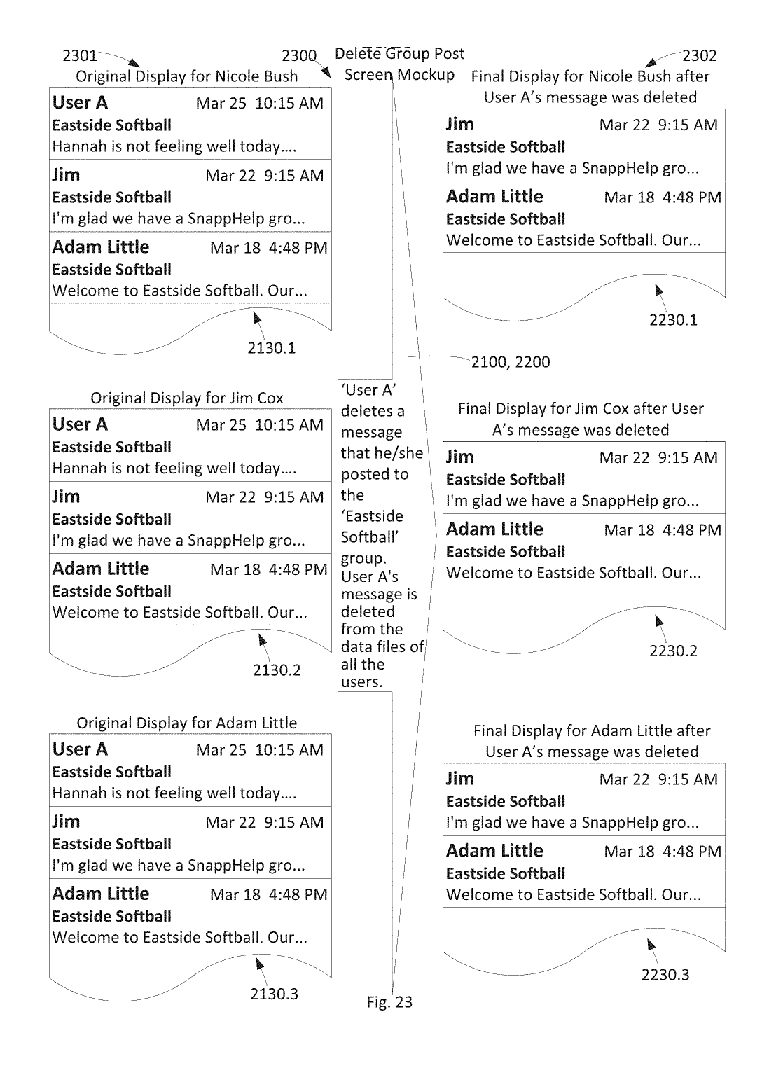

Referring now to FIG. 23, by way of example, and not limitation, there is illustrated user 220, such as ‘Nicole Bush’ 2130.1, user 220, such as ‘Jim Cox’ 2130.2, user 220, such as ‘Adam Little’ 2130.3 displays 208 displaying screen shots 2300, the steps set forth in FIGS. 21 and 22. Web server 260 displays communications between users 220 user 220, such as ‘Nicole Bush’ 2130.1, user 220, such as ‘Jim Cox’ 2130.2, user 220, such as ‘Adam Little’ 2130.3 deleting a message to a group/community, such as ‘Eastside Softball’ group/community’ (Group), shown as original Display 2301 and Final Display 2302.

Original Display 2301

In block or step 2130.1 user 220, such as ‘Nicole Bush’ 2130.1 display 208 displays “User A March 25 10:15 AM Eastside Softball Hannah is not feeling well today . . . ”; “Jim March 22 9:15 AM Eastside Softball I'm glad we have a SnappHelp gro . . . ”; “Adam Little March 18 4:48 PM Eastside Softball Welcome to Eastside Softball. Our . . . ”

In block or step 2130.2 user 220, such as ‘Jim Cox’ 2130.2 display 208 displays “User A March 25 10:15 AM Eastside Softball Hannah is not feeling well today . . . ”; “Jim March 22 9:15 AM Eastside Softball I'm glad we have a SnappHelp gro . . . ”; “Adam Little March 18 4:48 PM Eastside Softball Welcome to Eastside Softball. Our . . . ”

In block or step 2130.3 user 220, such as ‘Adam Little’ 2130.3 display 208 displays “User A March 25 10:15 AM Eastside Softball Hannah is not feeling well today . . . ”; “Jim March 22 9:15 AM Eastside Softball I'm glad we have a SnappHelp gro . . . ”; “Adam Little March 18 4:48 PM Eastside Softball Welcome to Eastside Softball. Our . . . ”

Final Display 2302

Next, in block or step 2230.1 user 220, such as ‘Nicole Bush’ 2230.1 display 208 displays “Jim March 22 9:15 AM Eastside Softball I'm glad we have a SnappHelp gro . . . ”; “Adam Little March 18 4:48 PM Eastside Softball Welcome to Eastside Softball. Our . . . ”

In block or step 2230.2 user 220, such as ‘Jim Cox’ 2230.2 display 208 displays “Jim March 22 9:15 AM Eastside Softball I'm glad we have a SnappHelp gro . . . ”; “Adam Little March 18 4:48 PM Eastside Softball Welcome to Eastside Softball. Our . . . ”

In block or step 2230.3 user 220, such as ‘Adam Little’ 2230.3 display 208 displays “Jim March 22 9:15 AM Eastside Softball I'm glad we have a SnappHelp gro . . . ”; “Adam Little March 18 4:48 PM Eastside Softball Welcome to Eastside Softball. Our . . . ”

It is contemplated herein that computer-implemented method 201 for communicating with select group(s) of users 220 may delete prior message or notifications from users 220 display 208 within a group/community, such as ‘Eastside Softball’ group/community’ (Group) without permission or consent of the other users 220.

The foregoing description and drawings comprise illustrative embodiments of the present disclosure. Having thus described exemplary embodiments, it should be noted by those of ordinary skill in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

What is claimed is:

1. A computer-implemented method for communicating with select group(s) of users comprising executing the steps of:
providing a network, a database, a server running a business rules engine, said server communicating with said database;
at least one first computer apparatus having a display and a network connection to communicate with said server;
at least one second computer apparatus having a display and a network connection to communicate with said server; and
a notification server configured to enable a plurality of communications between users, said users including one or more service providers via said at least one first computer apparatus and one or more service requestors via said at least one second computer apparatus, and storage of said communications in said database;
wherein said business rules engine is configured to enable searching of data files, searching service providers, searching said service requestors, to enable communicating between said service providers and said service requestors, and to enable selecting of said service providers and scheduling of a service to be performed by said service providers.

2. The method of claim 1, wherein said business rules engine is further configured to enable said service providers to add a skill to a data file of said service providers.

3. The method of claim 2, wherein said business rules engine searches a plurality of pre-existing and new communications relating to said skill, identifies a skill communication, and adds said skill communication to said data file of a service provider.

4. The method of claim 3, wherein said business rules engine communicates said data file of said service provider to said display of said at least one first computer apparatus.

5. The method of claim 4, wherein said business rules engine is configured to enable said service provider to delete a skill from said data file of said service provider and wherein said service provider communicates an action to delete said skill to said business rules engine.

6. The method of claim 5, wherein said business rules engine searches said plurality of communications relating to said skill, identifies said skill communication, and deletes said skill communication from said data file of said service provider, a delete skill data file.

7. The method of claim 6, wherein said business rules engine communicates said delete skill data file of said service provider to said display of said at least one first computer apparatus.

8. The method of claim 1, wherein said business rules engine is further configured to enable a service requestor to add a service request to a data file of said service requestor.

9. The method of claim 8, wherein said business rules engine searches said data files of said service requestors relating to said service request, identifying one or more service providers matching said service request and adds said service request to a data file of said one or more service providers matching said service request.

10. The method of claim 9, wherein said business rules engine communicates said service request to said one or more service providers matching said service request and to said display of said at least one first computer apparatus for said one or more service providers.

11. The method of claim 10, wherein said business rules engine is configured to enable said service requestor to delete a service request from said data file of said service requestor, and wherein said service requestor communicates an action to delete said service request to said business rules engine.

12. The method of claim 11, wherein said business rules engine searches said one or more service providers matching said service request and deletes said service request from said data file of each of said one or more service providers, a delete service request data file.

13. The method of claim 12, wherein said business rules engine communicates said delete service request data file of said service requestor to said display of each of said at least one first computer apparatus of each said one or more service providers matching said service request.

14. The method of claim 1, wherein said business rules engine is further configured to enable communication between said users and stores said communication in a communication data file.

15. The method of claim 14, wherein said business rules engine is configured to enable a user to delete said communication data file, and wherein said user communicates an action to delete said communication data file to said business rules engine.

16. The method of claim 15, wherein said business rules engine searches said data files of said users, identifying said communication data file between said users and deletes said communication data file, a delete communication data file.

17. The method of claim 16, wherein said business rules engine communicates said delete communication data file to said display of each of said user affiliated with said communication file.

18. The method of claim 1, wherein said business rules engine is further configured to enable a user to join a group of said users in group communication, and wherein said user communicates an action to join said group to said business rules engine.

19. The method of claim 18, wherein said business rules engine searches group of said users in group communication, identifying group communication data file and adds said user to said group communication data file to receive said group communication.

20. The method of claim 19, wherein said business rules engine searches a plurality of pre-existing and new communications relating to said group, and adds said group communication data file to said data file of said user.

21. The method of claim 20, wherein said business rules engine is configured to enable said user to leave a group of said users in group communication, and wherein said user communicates an action to leave said group to said business rules engine.

22. The method of claim 21, wherein said business rules engine searches said group communications data file, identifying said data file of said user and deletes said data file of said user from said group communications data file, a delete communication data file.

23. The method of claim 22, wherein said business rules engine communicates said delete communication data file to said user.

24. The method of claim 20, wherein said business rules engine is further configured to enable a user to communicate with said users in group communication, and wherein said user communicates an action to communicate with said group to said business rules engine.

25. The method of claim 24, wherein said business rules engine is further configured to enable communication between said users and said users in group communication and stores said user communication in said group communication data file.

26. The method of claim 25, wherein said business rules engine is configured to enable a user to delete a user data file from said group communication data file, and wherein said user communicates an action to delete said user data file to said business rules engine.

27. The method of claim 26, wherein said business rules engine searches said group communication data file, identifying said user data file affiliated with said group communication data file and deletes said user data file, a delete group communication data file.

28. The method of claim 27, wherein said business rules engine communicates said delete group communication data file to said group of said users.
